(19) United States
(12) Patent Application Publication
(10) Pub. No.: US 2017/0078436 A1
(43) Pub. Date: Mar. 16, 2017

(54) WIRELESS COMMUNICATION DEVICE, COMMUNICATION DEVICE, AND WIRELESS COMMUNICATION SYSTEM

(71) Applicant: KABUSHIKI KAISHA TOSHIBA, Tokyo (JP)

(72) Inventors: Takeshi ISHIHARA, Yokohama (JP); Hiroshi NISHIMOTO, Yokohama (JP)

(21) Appl. No.: 15/263,603

(22) Filed: Sep. 13, 2016

(30) Foreign Application Priority Data
Sep. 14, 2015 (JP) 2015-181149

(51) Int. Cl. H04L 29/08

(52) U.S. Cl. CPC H04L 67/2842; H04W 84/12

(57) ABSTRACT

According to an embodiment of the present invention, a wireless communication device includes a communication interface, a transferer, a storage, a storage controller, and a first controller. The transferer transfers a communication request acquired from a wireless communication terminal via the wireless connection by way of the communication interface or a different communication interface to a communication device which extracts a requested information identifier. The storage stores given information. The storage controller treats information in the storage. The first controller, in a case of receiving a save instruction from the communication device, instructs the storage controller to save information in the storage, and, in a case of receiving a response instruction from the communication device, instructs the storage controller to read out information specified by the response instruction to transmit the information read out via the wireless connection to the terminal specified by the response instruction.

### CROSS-REFERENCE TO RELATED APPLICATION (S)

This application is based upon and claims the benefit of priority from Japanese Patent Application No. 2015-181149, filed Sep. 14, 2015; the entire contents of which are incorporated herein by reference.

### FIELD

Embodiments described herein relate generally to a wireless communication device, a communication device, and a wireless communication system.

### BACKGROUND

There has been widely known a wireless LAN (Local Area Network) that is a wireless communication system in which a wireless communication terminal performs communication via a wireless base station device (access point). In the wireless LAN based on the IEEE802.11 communication standard, the access point, which has a function to convert a physical medium between the wireless LAN and a wired LAN, connects communication coming from the wireless communication terminal with a back-end network configured by wired communication technologies to enable communication with a server or the like existing over the back-end network. An access point controller collectively manages plural access points and provides an upper function such as user authentication and network isolation by association between a VLAN and an SSID, for example.

However, the functions of the access point and the access point controller are closed in each device, and a cooperative operation between the devices is not taken into account, and therefore, data delivered over the network has just been simply transferred in principle. In contrast to this, a communication scheme (Content-Centric Networking: CCN) has been proposed that a communication device like the access point having a cache function to transitorily save the data or the like transmits the saved cache. The CCN may use plural caches existing on the network to give effects such as decrease in communication traffic of the entire network and reduction in response time.

If the cache is held in logically the closest access point which is connected to the wireless communication terminal, such an effect as a shortened response time is obtained. However, in order to send the cache, processes are needed such as analysis of a communication request from the wireless communication terminal, and confirmation of whether or not the cache is saved. Thus, increased complexity of the access point, an increasing amount of processing and the like involve occurrence of a problem such as increase in a heat generation amount and power consumption, or increase in a size of the device. Even in a case where a dedicated cache device is prepared to be made to collectively process requirements coming from the plural networks, a large-scale device is needed depending on the process amount.

In addition, even if a well-known cache technology is deployed as it is in a wireless LAN system, the desired performance may not be achieved. For example, in a case where the wireless LAN includes a plurality of access points, even if the wireless communication terminal do not get radiowaves from the connected access point by movement, the wireless communication terminal may keep the communication by roaming as acquiring radiowaves from another access point. However, since information transmission from the cache is associated with a specific access point, a simple wireless LAN roaming cannot resolve the above.

### BRIEF DESCRIPTION OF THE DRAWINGS

FIG. 1 is a diagram showing an example of a communication environment in a wireless communication system according to a first embodiment;

FIG. 2 is a diagram showing an example of a communication sequence of the wireless communication system according to the first embodiment;

FIG. 3 is a diagram showing another example of the communication sequence of the wireless communication system according to the first embodiment;

FIG. 4 is a block diagram showing a schematic configuration of an AP according to the first embodiment;

FIG. 5 is an exemplary sequence diagram of a response process in the AP according to the first embodiment;

FIG. 6 is another exemplary sequence diagram of the response process in the AP according to the first embodiment;

FIG. 7 is a block diagram showing a schematic configuration of a WLC according to the first embodiment;

FIG. 8 is a diagram showing an example of cache management information according to the first embodiment;

FIG. 9 is a diagram showing an example of an operational sequence of the WLC according to the first embodiment;

FIG. 10 is a diagram showing another example of the operational sequence of the WLC according to the first embodiment;

FIGS. 11A and 11B are each a diagram showing another example of the communication environment in the wireless communication system according to the first embodiment;

FIG. 12 is a diagram showing an example of a communication sequence of a wireless communication system according to a second embodiment;

FIG. 13 is a diagram showing another example of the communication sequence of the wireless communication system according to the second embodiment;

FIG. 14 is a block diagram showing a schematic configuration of an AP according to the second embodiment;

FIG. 15 is a block diagram showing a schematic configuration of an AP according to a third embodiment;

FIG. 16 is a block diagram showing a schematic configuration of a WLC according to the third embodiment;

FIG. 17 is a diagram showing an example of a communication sequence of a wireless communication system according to the third embodiment;

FIGS. 18A and 18B are each a diagram showing an example of a configuration in which an external server acquires pertinent information;

FIG. 19 is a block diagram showing a schematic configuration of an AP according to a fourth embodiment;

FIG. 20 is a block diagram showing a schematic configuration of a WLC according to the fourth embodiment;

FIG. 21 is a diagram showing an example of a communication sequence of a wireless communication system according to the fourth embodiment;

FIG. 22 is a diagram showing an example of a communication sequence of a wireless communication system according to a fifth embodiment;

FIG. 23 is a diagram showing another example of the communication sequence of the wireless communication system according to the fifth embodiment;

FIG. 24 is a diagram illustrating a wireless communication system according to a sixth embodiment;

FIGS. 25A to 25C are each a diagram showing an example of cache management information according to the sixth embodiment; and

FIG. 26 is a block diagram showing an exemplary hardware configuration in which the wireless communication device according to the embodiment is achieved.

### DETAILED DESCRIPTION

An Embodiment of the present invention uses a cache effectively taking into account the loads of communication devices and a whole of a wireless communication system uses the cache function.

According to an embodiment of the present invention, a wireless communication device includes a communication interface, a transferer, a storage, a storage controller, and a first controller. The transferer transfers a communication request acquired from a wireless communication terminal via the wireless connection by way of the communication interface or a different communication interface to a communication device which extracts a requested information identifier. The storage stores given information. The storage controller treats information in the storage. The first controller, in a case of receiving a save instruction from the communication device, instructs the storage controller to save information in the storage, and, in a case of receiving a response instruction from the communication device, instructs the storage controller to read out information specified by the response instruction to transmit the information read out via the wireless connection to the terminal specified by the response instruction.

Below, a description is given of embodiments of the present invention with reference to the drawings. The present invention is not limited to the embodiments.

### First Embodiment

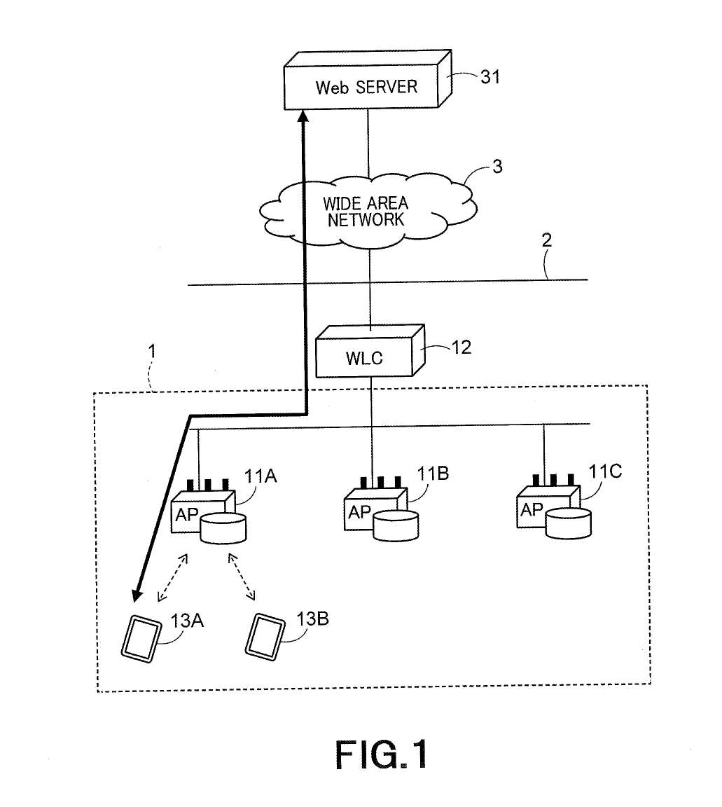

FIG. 1 is a diagram showing an example of a communication environment in a wireless communication system according to a first embodiment. In this communication environment, a network 1, a network 2, and a wide area network 3 are shown.

In the network 1, there are an access point (AP) 11 as a wireless communication device, a wireless LAN controller (WLC) 12 controlling the AP 11, and a wireless communication terminal 13. FIG. 1 shows three APs 11 (11A, 11B, and 11C), one WLC 12, and two wireless communication terminals 13 (13A and 13B). Note that the access point is also one form of a wireless communication terminal. The AP 11 means the APs 11A, 11B, and 11C, and the wireless communication terminal 13 means the terminals 13A and 13B in the following description unless otherwise specifically described.

The network 2 is connected via the WLC 12 with the network 1. The wide area network 3 is connected via the network 2 with the network 1. The wide area network 3 is connected with a network not shown and a web server 31 is connected on the network not shown. Here, assume that the wireless communication terminal 13 requests information from the web server 31 to acquire the information as shown by an arrow in FIG. 1. Note that the web server 31 is an example. The acquired information is not limited to information concerning a web. The information provision device is not limited to the web server 31. Any information and information provision device may be targeted .

Note that FIG. 1 is an example without limitation. The networks may include other devices not shown and may be connected with other networks not shown. Here, the network 2 is assumed to be connected via the WLC 12 with the network 1, but may be connected with the network 1 without the WLC 12. The WLC 12 may be not on the network 1, but on another network connected with the wide area network 3 and may manage from there.

The devices in the network 1 are logically connected to be able to communicate with each other in a wired or wireless manner. Here, the AP 11, which includes one or more antennas, can wirelessly communicate with the wireless communication terminal 13 by emitting radiowave signals into space. The communication between the APs 11 and the communication between the AP 11 and the WLC 12 are assumed to be performed in a wired manner, but these communications may be performed wirelessly. Wireless communication includes a wireless LAN, cellular communication, a short-range wireless network based on IEEE802.15.4, infrared communication, visible light communication and other wireless communication technology. Networks not shown described above may be networks configured by these communication technologies.

The wireless communication terminal 13 and WLC 12 are communicably connected via the AP 11. The WLC 12 manages the APs 11, and the APs 11 publishes a common SSID to provide the network 1 as a wireless LAN to the wireless communication terminals 13. A procedure or the like of accessing the network 1 complies with standards defined by IEEE802.11 or the like.

In a case where each wireless communication terminal 13 communicates with a network resource (server, etc.) other than the network 1, communication packets are collected to the WLC 12 and transferred to a proper network. If a communication counterpart device is not in the network 2, the packet is sent via the wide area network 3 to the web server 31 as a communication counterpart device. Inversely, the communication packets sent from the web server 31 are transefered via the WLC 12 to the wireless communication terminals 13.

The APs 11 each have a storage mounted thereon. The storage transitorily stores the information requested or expected to be requested by the wireless communication terminal 13. Here, the information stored in the storage is referred to as cached information. The APs 11 extracts the cached information and responds in place of the communication counterpart such as the web server 31 when the wireless communication terminals 13 request the information. A function to provide the requested information by way of the cached information extraction and response in this way is called a cache function. This cache function can reduce traffic flowing through the wide area network 3. In addition, a time period until the wireless communication terminal 13 acquires the information may be shortened.

However, in order to attain the cache function, besides the process of accumulating in the storage, at least three processes, packet scanning, hit determination, and information acquisition are required.

The packet scanning is a process of reading an identifier identifying the requested information from the packets acquired. Here, this identifier is referred to as a requested information identifier. Examples of the requested information identifier include a URL, a file name (which is in a form different from the URL and can identify the file), and a specific bit pattern, and may be information so long as it is capable of being read from the packets.

The hit determination is a process of determining whether or not caching can be performed. To determine whether or not caching can be performed, it is confirmed whether information concerning the requested information identifier identified by the packet scanning is stored in the storage and usable. A destination to save the cached information is also identified. For example, in a case where the AP 11 includes a plurality of storages, the storage saving the cached information needs to be identified. For example, in a case where the cached information stored in the storage of each of the AP 11 is different, the AP 11 having the required cached information needs to be identified.

The information acquisition (content acquisition) is a process of, responsive to a determination result of the hit determination, actually acquiring the information concerning the requested information identifier identified by the packet scanning. If the storage storing the information to acquire is an external device, communicably connection with the external device is required. The acquired information is stored in the storage.

If the APs 11 are made to perform all the processes regarding the cache function, processing loads on the APs 11 increase, leading to occurrence of problems such as processing delay, power consumption increase, and device size increase. On the other hand, if the cache function is attained, transmission of the cached information to the wireless communication terminal 13 is desirably made by the AP 11 which is logically close to the wireless communication terminal 13 in terms of delay, bandwidth of use and the like. Accordingly, in the embodiment, the above problems for the AP 11 are resolved by making the WLC 12 to perform the processes such as the packet scanning while the storage is provided to the AP 11.

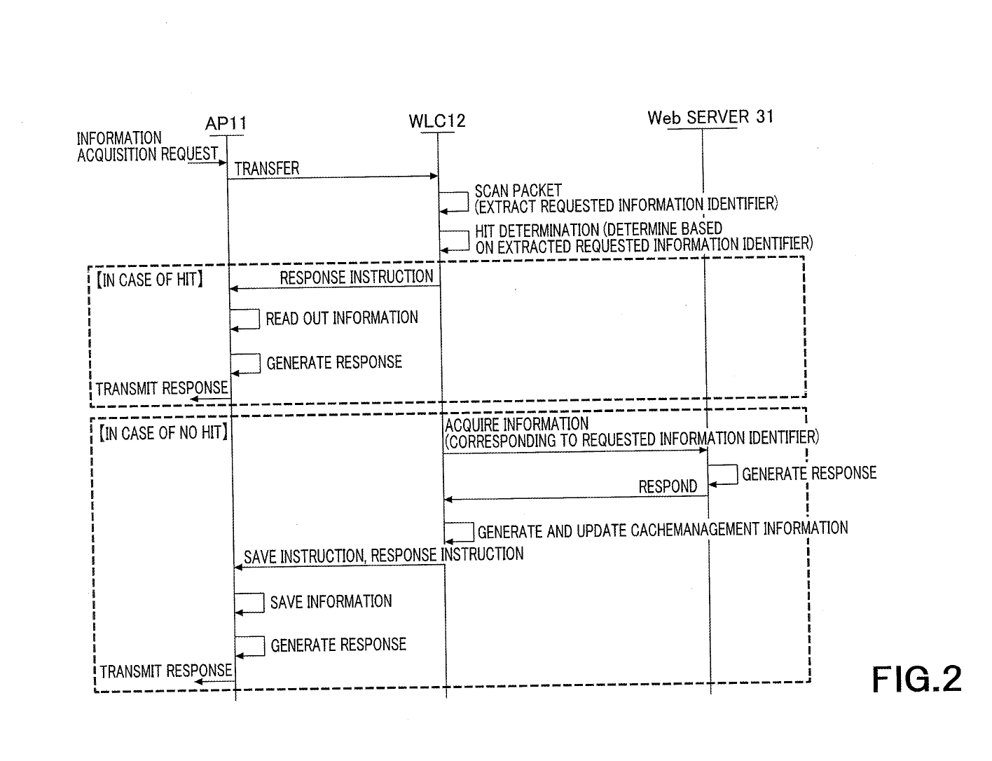

FIG. 2 is a diagram showing an example of a communication sequence of the wireless communication system according to the first embodiment. Of two frames surrounded by a broken line in FIG. 2, a portion surrounded by the upper frame illustrates a case where the hit determination is true. A portion surrounded by the lower frame illustrates a case where the hit determination is false. This sequence is for the case where an information acquisition request from the wireless communication terminal 13 connected with the AP 11A is received by the AP 11A.

When the AP 11A receives the information acquisition request, it promptly transfers the information acquisition request to the WLC 12. The WLC 12 performs the packet scanning for the transferred information acquisition request to extract the requested information identifier. For example, if the information acquisition request is concerned with an HTTP, the WLC 12 analyzes an HTTP header, extracts a HTTP method such as “GET”, and extracts a URL described in the HTTP method. Even for a format other than the HTTP, the WLC 12 scans from the beginning of the packets to extract intended information.

If the requested information identifier can be extracted, the WLC 12 performs the hit determination. Specifically, the WLC 12 searches the cache management information managed by the WLC 12 to check whether or not information of target is held in the cache. If an expiration time is set for the cache management information, validity of the information to be extracted is also confirmed. Note that the cache management information managed by the WLC 12 may include information of a storage held by a communication device such as an external server other than the APs 11 as those to be managed.

If the storage of the AP 11A is confirmed to hold the valid information, that is, if it is determined that there is a cache, the WLC 12 transmits a response instruction (response request) to the AP 11A holding the relevant cache. This response instruction contains the requested information identifier and an identifier identifying a counterpart to respond such as an IP address. Moreover, if the WLC 12 terminates a TCP connection between the wireless communication terminal 13 and the web server 31, information concerning the TCP connection may be contained.

When the AP 11A receives the response instruction, it reads out the instructed cached information from the storage to generate a response. If the AP is instructed by the WLC 12 to take over the TCP connection, it uses the information concerning the instructed TCP connection to change a state of a TCP stack of the AP 11A, such as assigning a port number and setting a sequence number, to take over the TCP connection. After completion of preparing for transmitting the response, the AP 11A transmits the response to the wireless communication terminal 13. Note that the AP 11A may mimic a response from the web server 31 to which the wireless communication terminal 13 requests.

Alternatively, the AP 11A may transmit the response after the communication between the wireless communication terminal 13 and the web server 31 is changed over to the communication between AP 11A and the wireless communication terminal 13. A method for changing over the communication includes a redirect method. Specifically, the method is as follows. in the communication between the wireless communication terminal 13 and the web server 31, the WLC 12 transmits a rediectrequest and declines the current communication. The wireless communication terminal 13 receiving the redirect request sends the same information acquisition request to AP 11A as a redirected destination contained in the redirect request. After receiving the information acquisition request, the AP 11A reads out the cache from the storage and responds.

On the other hand, as a result of the hit determination by the WLC 12, in a case where the cache of any AP 11 does not hit (case where the hit determination is false in FIG. 2), the WLC 12 transmits the information acquisition request to the web server 31 which holds original information. The web server 31 receiving the information acquisition request generates a response to send in return to the wireless communication terminal 13. The WLC 12 detects the response of the web server 31 to generate the cache management information. Information included in the response may be transitorily accumulated within the WLC 12. After that, the WLC 12 instructs the AP 11A to save the cached information (save instruction) and to transmit a response to the wireless communication terminal 13 transmitting the request (response instruction), and transfers the acquired information to the AP 11A. After this, similarly to the case where the hit determination is true, the AP 11A saves the information, generates a response and transmits the response to the wireless communication terminal 13.

Note that if the WLC 12 transmits the information acquisition request to the web server 31 which holds original information, it may transmit a request mimicking the wireless communication terminal 13. In that case, the WLC 12 may generate and transmit to the web server 31 a request having the same setting as the information such as a source IP address and a structure of the HTTP header which are contained in the request transmitted by the wireless communication terminal 13.

Here, the AP 11A is assumed to save the cached information, but may, without saving, respond to the wireless communication terminal 13. For example, there may be considered a case where the storage does not have a sufficient free space or a case where a predetermined save condition is not satisfied.

Next, a description is given of a case where the AP 11 transferring the request is different from the AP 11 holding the storage in which the desired information is saved. Here, assume that the AP transferring the request is the AP 11A, and the AP holding the storage storing the desired information is the AP 11B.

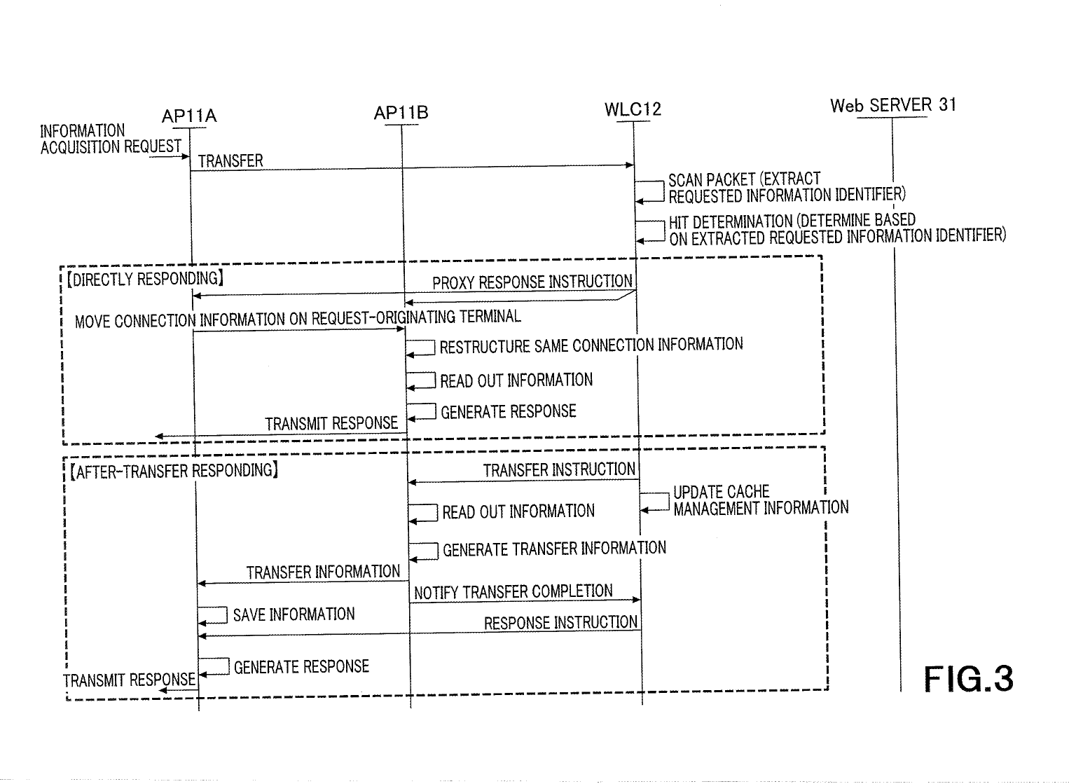

FIG. 3 is a diagram showing another example of the communication sequence of the wireless communication system according to the first embodiment. FIG. 3 shows a case where the AP transferring the request is different from the AP holding the storage in which the desired information is saved. FIG. 3 shows two ways for a case where the AP 11B holding the cache returns a response and a case of responding after the cache is transmitted from the AP 11B holding the cache to the AP 11A.

Of two frames surrounded by a broken line in FIG. 3, a portion surrounded by the upper frame illustrates the case where the AP holding the cache directly returns a response. This case is, except that the response instruction is transmitted not to the AP 11A transferring the information acquisition request to the WLC 12 but to the AP 11B holding the cache, similar to the case where the hit determination is true shown in FIG. 2. In a case where the wireless communication terminal 13 requesting the information exists in a wireless area range provided by the save-destination AP 11B, and the save-destination AP 11B can directly communicate with the wireless communication terminal 13 requesting the information, delay may be suppressed in the case where the save-destination AP 11B directly responds rather than the case of responding after the cache is transmitted.

The WLC 12 instructs the request source AP 11A and the new connection destination AP 11B to change over the connection of the wireless communication terminal 13 and transmit a response regarding the requested information (proxy response instruction). The AP 11A, transfers to the AP 11B information on the terminals connecting therewith, for example, information on association at a wireless LAN level, and TCP connection information at a TCP/IP level, such that the communication started by the wireless communication terminal 13 with the AP 11A is taken over with the AP 11B. The AP 11B makes reflection on the basis of the received information to establish the connection with the wireless communication terminal 13. Note that in changing over, the AP 11A may instruct the wireless communication terminal 13 to change the connection destination.

The AP 11 may notifies completion of changing over and completion of copying the information to the WLC 12 such that the WLC 12 may manage conditions.

A case may be considered where there are plural APs 11 holding the requested information, but here assume that the AP 11 which is to transmit the cache is uniquely settled. An embodiment of selecting the AP 11 which is to transmit the cache is described later.

A portion surrounded by the lower frame in FIG. 3 illustrates the case of responding after the cached information is transmitted (after-transfer responding). In the case of responding after the cached information is transmitted, the cached information is transferred from the AP 11B having the cache to the AP 11A. As shown in FIG. 3, the transfer is made in accordance with a transfer instruction from the WLC 12. As for a method for transferring the cached information, an existing file transfer scheme such as HTTP, FTP, SCP, or the like may be used. If the cached information is properly transferred, the AP 11B notifies transfer completion to the WLC 12 and the WLC 12 gives the response instruction to the AP 11. Subsequent procedures are the same as in the case described above and a description thereof is omitted.

In a case where both the directly responding and the after-transfer responding may be used, which of them is used may be predetermined by an administrator of the network or the like. Alternatively, conditions may be determined in advance such that the WLC 12 selects the method on the basis of the relevant conditions. For example, it may be considered that saving a network bandwidth, saving amount of storage used and the like are prioritized, and if a data size of the cached information to transmit exceeds a threshold, transmission is not performed. Inversely, it may be considered that reduction of response delay is prioritized, and if the estimated response delay exceeds a threshold, transmission is performed. Besides, a frequency of request from the wireless communication terminal 13, a priority of the wireless communication terminal 13 requesting, a radiowave condition of the wireless communication terminal 13 requesting and the like may be considered to be conditioned. Other conditions may be applied or these conditions may be combined. Note that a conditional judgment may be made after the WLC 12 performs the hit determination.

In the case where the request frequency is conditioned, the following examples may be considered. For example, after the number of times of request from a specific wireless communication terminal 13 exceeds a predetermined threshold within a certain time period, when a request is received from that specific wireless communication terminal 13, the after-transfer responding is performed. Alternatively, after the number of times of request for specific cached information exceeds a predetermined threshold within a certain time period, when that specific cache is requested, the after-transfer responding is performed.

In the case where the priority is conditioned, the following examples may be considered. For example, a priority is placed on each wireless communication terminal 13 in advance such that the directly responding or the after-transfer responding is determined on the basis of the relevant priority. Alternatively, in an environment where there are plural networks such as an intracompany network and a guest network, a priority is placed on each network in advance such that the directly responding or the after-transfer responding is determined on the basis of the priority of the network to which the wireless communication terminal 13 transmitting the request belongs. If the higher priority is placed on the intracompany network, it may be considered that the request from the wireless communication terminal 13 connected with the intracompany network is responded after transmission, and the wireless communication terminal 13 connected with the guest network is directly responded.

In the case where the radiowave condition is conditioned, for example, it may be considered that the wireless communication terminal 13 for which the radiowave condition is determined to be good in terms of a radiowave intensity (RSSI strength) or the like is responded after transmission, and the wireless communication terminal 13 for which the radiowave condition is determined to be bad is directly responded without transmission.

Note that, here, the request source AP 11 or the save-destination AP 11 returns a response, but in some cases other AP 11 than the request source AP 11 or save-destination AP 11 may more properly respond such as when the wireless communication terminal 13 moves. An embodiment of selecting the AP 11 which is to respond is described later.

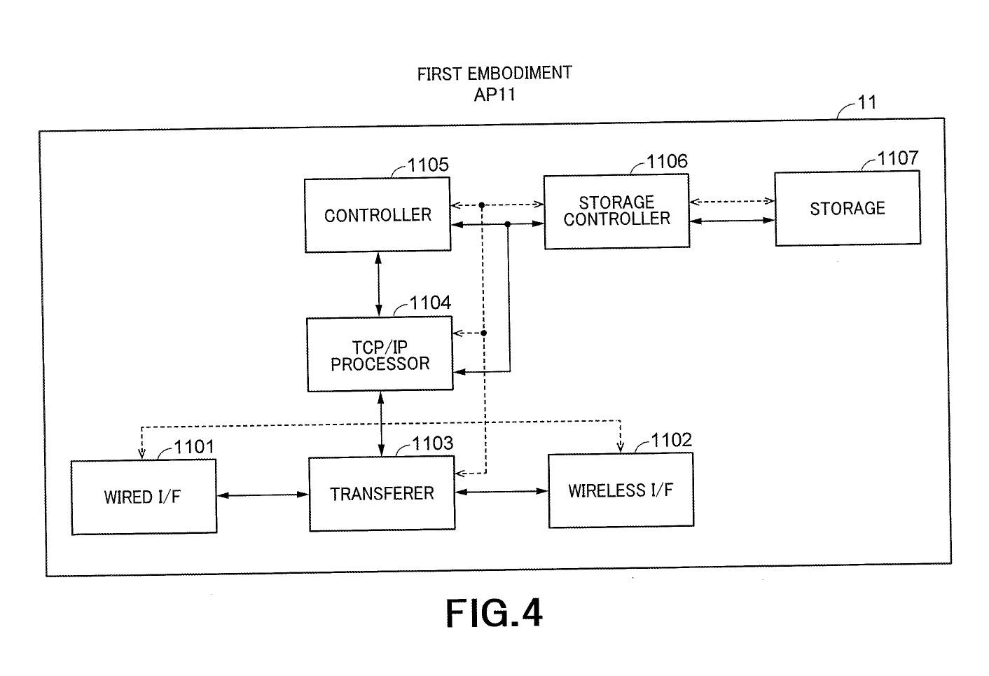

FIG. 4 is a block diagram showing a schematic configuration of the AP 11 according to the first embodiment. The AP according to the first embodiment includes a wired interface (wired I/F) 1101, a wireless interface (wireless I/F) 1102, a transferer 1103, a TCP/IP processor 1104, a controller 1105, a storage controller 1106, and a storage 1107. A solid arrow represents a control relation and a broken line arrow represents a flow of data.

The wired interface 1101 is an interface communicably connecting the AP 11 with the WLC 12. The wireless interface 1102, which provides a wireless network to the wireless communication terminal 13, is an interface for communicably connecting the wireless communication terminal 13 with the AP 11.

The transferer 1103 is a bridge exchanging frames between the wired interface 1101 and the wireless interface 1102. The transferer 1103 also extracts a specific frame from acquired frames to transmit the extracted frame to the TCP/IP processor 1104. The TCP/IP processor 1104 performs a process of TCP, a process of IP, and various processes required for supporting the communication performed by use of the TCP/IP. The various processes required for supporting includes, for example, a process of an auxiliary communication using a UDP, management using an ICMP, and error notification.

Note that the frame described in the embodiment may be not only those called a frame in the IEEE802.11 standard, for example, but may refer to those called a packet, and the frame and the packet are not particularly distinguished from each other unless otherwise specifically described.

The controller 1105 governs an operation of the AP 11 and gives other components instructions regarding the processes in accordance with the instruction from the WLC 12. The storage controller 1106 controls the information stored in the storage on the basis of the instruction from the controller 1105. The storage 1107 saves, deletes and reads out (acquires) the cached information on the basis of the instruction by the storage controller 1106.

Note that a condition may be placed for saving the cached information in the storage 1107. For example, there may be a limitation on the data size of each saving, type of information to save, and the like. Additionally, the storage may be divided into plural regions to put a limitation on the storage of use for each type of information to save. For example, it may be considered that a movie file having a large data size can use 70% of the storage capacity, the image file can uses 20% of the storage capacity, and text data can use of 10% of the storage capacity.

The storage controller 1106 saves the cached information in accordance with the save condition. The storage controller 1106 may also change the save condition and a save area depending on the instruction from the WLC 12, a save state of the storage 1107, and a communication state with the wireless communication terminal 13. The save state includes a free space of the storage, a usage rate that is a ratio of a free space to an entire capacity of the storage and the like. The communication state includes the number of times of communication (frequency) with the wireless communication terminal 13 per a certain time period, the number of times of request (frequency) for the cached information per a certain time period, the radiowave condition such as the radiowave intensity, and the like. Information concerning the save condition and save area after saving may be notified to the WLC 12 such that the WLC 12 may manage the information.

Hereinafter, a description is given of operations of the components in the AP 11. First, in the case where the AP 11 receives the packets from the wireless communication terminal 13, since the process regarding the cache is not performed, each of the wireless interface 1102, the transferer 1103, and the wired interface 1101 performs a process of transfer. The transferer 1103 confirms a transmission destination of the packets and operates to simply relay the packets between both interfaces.

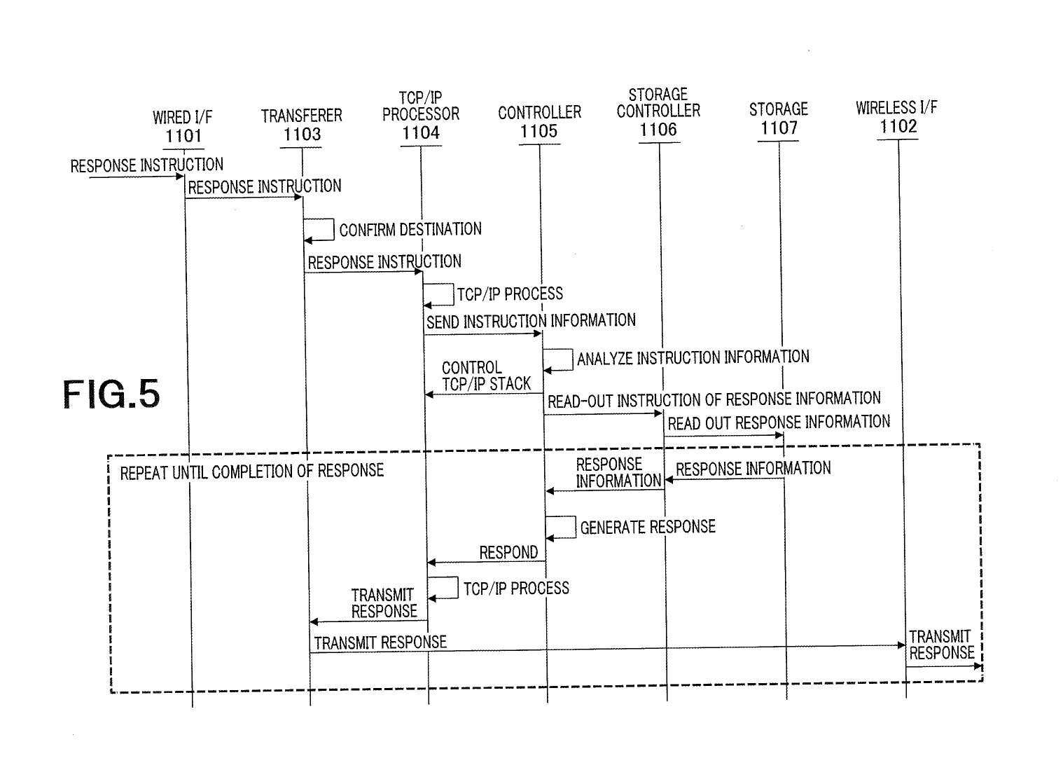

Next, a description is given of the case of receiving the response instruction from the WLC 12. FIG. 5 is an exemplary sequence diagram of a response process in the AP 11 according to the first embodiment. This process is the response process of the AP 11 in the case of the hit determination is true shown in FIG. 2 and case of the directly responding shown in FIG. 3. If the wired interface 1101 receives frames from the WLC 12, it transmits the frames to the transferer 1103. The transferer 1103 confirms a transmission source and destination of the frames and transmits the frames (packets) to the TCP/IP processor 1104. The TCP/IP processor 1104 performs a reception process for the packets transmitted thereto and transmits the instruction information contained in the packets to the controller 1105. The controller 1105 analyzes the instruction information to identify the cached information to transmit as a response. Then, the controller 1105 sends an instruction to read out the identified cached information to the storage controller 1106. The controller 1105 also instructs the TCP/IP processor 1104 to control a TCP/IP stack. The storage controller 1106 reads out the response information from the storage 1107. The controller 1105 generates a response from the information read out from the storage 1107, and the TCP/IP processor 1104 performs a transmission process for the packet containing the response such that the relevant packet is transmitted via the transferer 1103 and the wireless interface 1102 toward the wireless communication terminal 13. Note that in the case of the after-transfer responding shown in FIG. 4, that is, in the case where the AP 11 transferring the request is different from the AP 11 holding the storage in which the desired information is saved, the response information is transmitted not the wireless communication terminal 13 but to another AP 11.

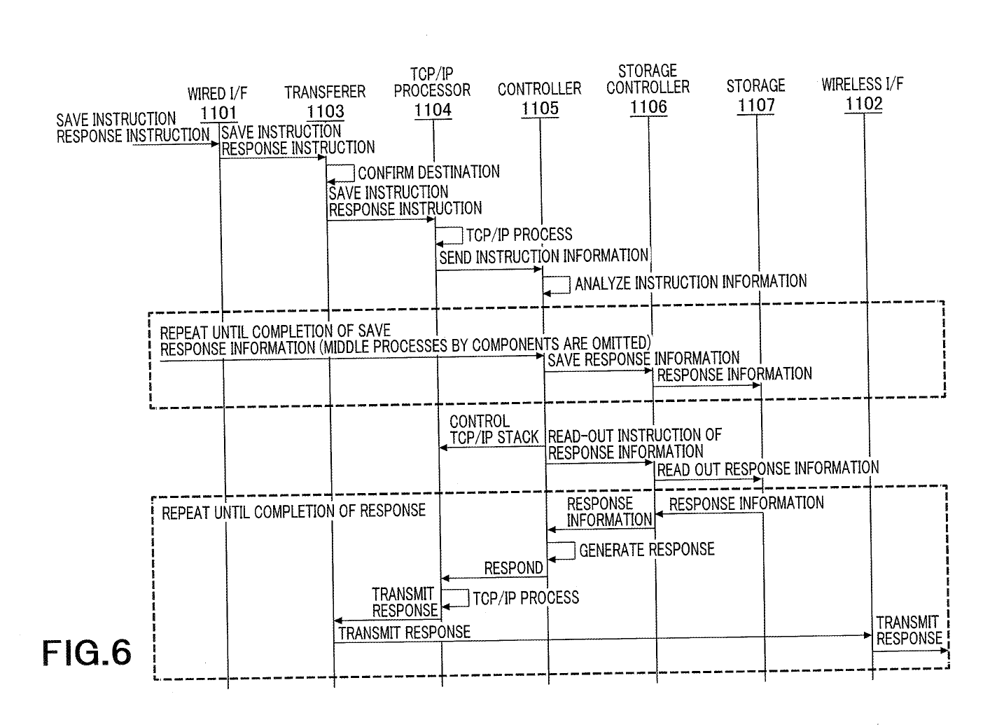

FIG. 6 is another exemplary sequence diagram of the response process in the AP 11 according to the first embodiment. FIG. 6 shows the response process of the AP 11 in the case of the hit determination is false shown in FIG. 2 and case of the after-transfer responding shown in FIG. 3. If the AP 11 receives the save instruction and the response instruction from the WLC 12, the components in the AP 11 perform processes of saving information and response.

The process from when the wired interface 1101 receives the packets from the WLC 12 until the instruction information contained in the packets is sent to the controller 1105 is the same as the response process. The controller 1105 recognizes the save instruction by analyzing the instruction information and instructs the storage controller 1106 to save the received response information. The storage controller 1106 saves the received response information in the storage 1107. A series of processes from receiving to saving is repeated until the all information to save is saved. At completion of saving, the controller 1105 instructs the TCP/IP processor 1104 to control the TCP/IP stack, and instructs the storage controller 1106 to read out the response information. Subsequent process is the same as the response processes in FIG. 5. Therefore a description thereof is omitted.

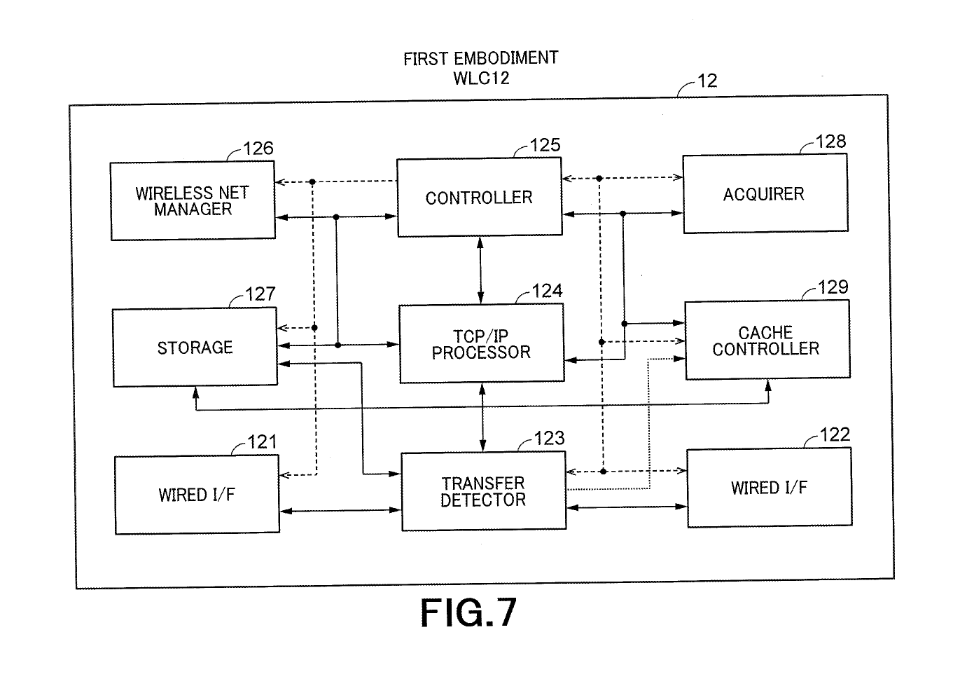

Next, a description is given of the WLC 12. FIG. 7 is a block diagram showing a schematic configuration of the WLC 12 according to the first embodiment. The WLC 12 according to the first embodiment includes two wired interfaces 121 and 122, a transfer detector 123, a TCP/IP processor 124, a controller 125, a wireless network manager 126, a cache controller 129, an acquirer 128, and a storage 127. A solid arrow represents a control relation and a broken line arrow represents a flow of data.

Note that two wired interfaces are provided, but may be three or more.

The wired interface 121 and the wired interface 122 are each an interface connecting the network. Here, the wired interfaces 121 and 122 may be the same type, or may be differently used by use of a combination of the SSID and the VLAN ID, or the like. Moreover, bonding may be used such that a plurality of physical interfaces may be used as one interface. Note that, here, assume that the wired interface 121 is connected with the network 1, and the wired interface 122 is connected with the network 2.

The transfer detector 123 transfers frames (packets) between the wired interfaces 121, the wired interfaces 122 and the TCP/IP processor 124. The transfer detector 123 also scans the packets to transfer and determines whether or not the packets meet a predetermined condition. Specifically, in a case where a specific area or a specific bit pattern appears in a packet of the packets to transfer, the packet is identified as target packet. Alternatively, the condition may be stored in the storage 127 such that the transfer detector 123 adequately refers to the storage 127. The transfer detector 123 may extract the requested information identifier from the identified target packet (information acquisition request). In a case where the transfer detector 123 does not extract the requested information identifier, the controller 125 extracts the requested information identifier.

The TCP/IP processor 124 performs the TCP/IP process for the packets to be treated by WLC 12. Further, the TCP/IP processor 124 also performs a process for an auxiliary communication protocol, similarly to the TCP/IP processor 1104 in the AP 11.

The controller 125 governs an operation of the WLC 12 and gives the instructions to the components in the WLC 12 and the AP 11. The controller 125 also performs other various processes. For example, if the transfer detector 123 does not extract the requested information identifier from the information acquisition request, the controller 125 extracts the requested information identifier. Note that, in the case where the controller 125 extracts the requested information identifier, the packet identified by the transfer detector 123 is sent via the TCP/IP processor 124.

The wireless network manager 126 manages concerning the wireless communication performed by the WLC 12 such as management of the APs 11 and wireless network. Specifically, the wireless network manager 126 practices AP 11 setting management, user management, wireless resource management and the like.

The storage 127 stores therein information used by the components in the AP 11. Examples of the stored information include a condition for identifying the packet to be processed by the transfer detector 123, a condition used to extract the requested information identifier by the transfer detector 123 or the controller 125, and an information managed by the wireless network manager 126. Example of the information managed by the wireless network manager 126 include information on the AP 11 in the network 1, information on the wireless communication terminal 13 connected with each AP, information on a user of the wireless communication terminal 13, and authentication information of the user. Additionally, the cached information held by the APs 11 may be saved in the storage 127. Alternatively, a mass storage not shown for transitorily saving the cached information may be provided separately from the storage 127.

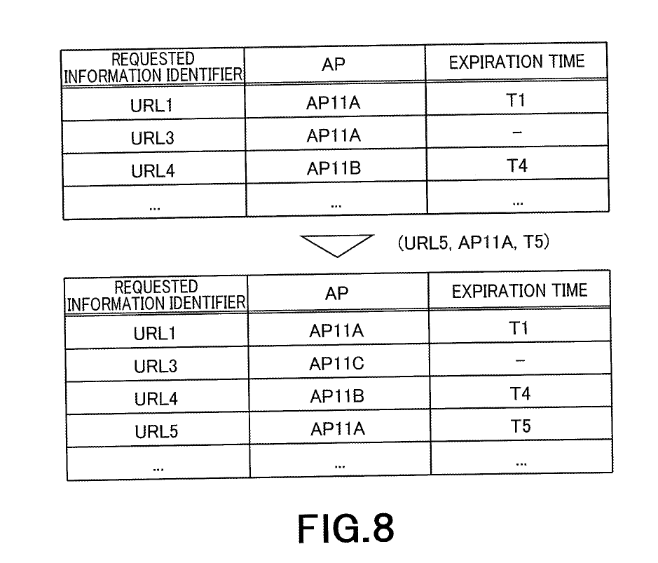

FIG. 8 is a diagram showing an example of the cache management information according to the first embodiment. In a upper table in FIG. 8, there are stored the requested information identifier, the AP 11 holding the cache regarding the relevant requested information identifier, and information concerning the expiration time for the relevant cache. The items are merely examples, and the expiration time may not be necessarily required and other items may be provided. When the WLC 12 gives the save instruction to AP 11A to newly cached information concerning a URL 5 and receives a transfer completion notification, the table is updated as a lower table shown in FIG. 8.

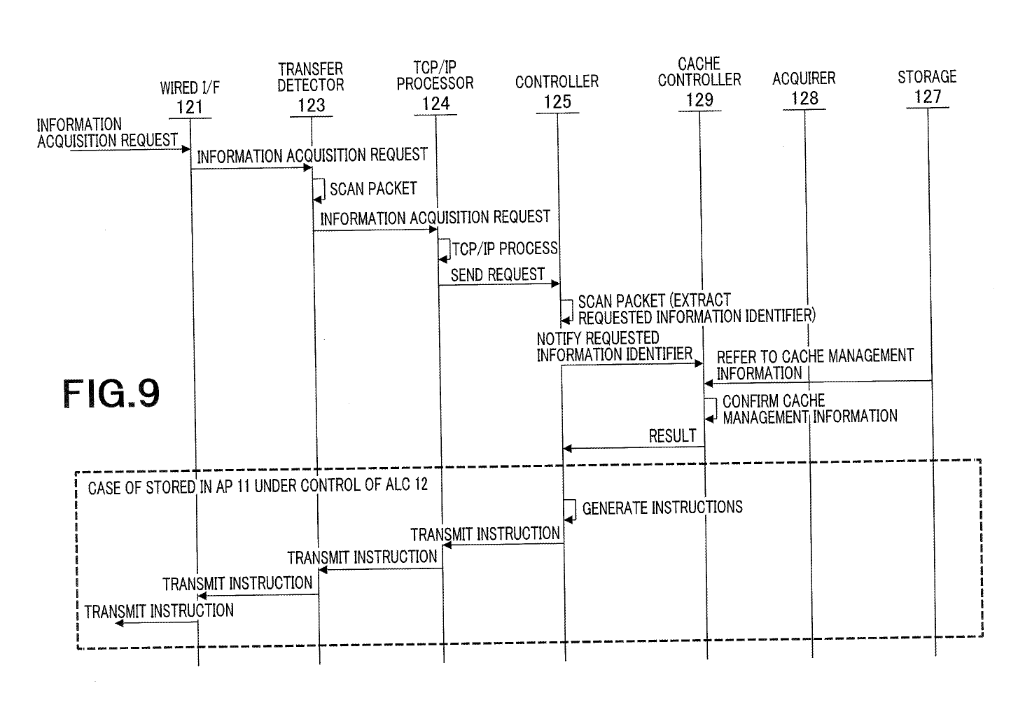

The cache controller 129 manages the cached information on the AP 11 under the control thereof on the basis of the cache management information. If the requested information is not cached in the AP 11 under the control of the WLC 12, the acquirer 128 acquires the requested information from an external information provision device such as the web server 31. Hereinafter, a description is given of operations of the components in the WLC 12. FIG. 9 shows an operational sequence of the WLC 12 according to the first embodiment. FIG. 9 shows a case where the requested information has been cached.

The wired interface 121 acquires the packets including the information acquisition request transferred from AP 11. The transfer detector 123 scans content of the relevant packets to determine the packets to be processed in the WLC 12, and the TCP/IP processor 124 performs the reception process.

The controller 125 extracts the requested information identifier contained in the message. The extracted requested information identifier is sent to the cache controller 129. The cache controller 129 searches the cache management information by use of the requested information identifier to determine whether or not there is the AP 11 having cached. A determination result is sent to the controller 125.

If the controller 125 obtains the determination result that the information is saved, it generates and sends the response instruction, the proxy response instruction, or the transfer instruction. As described above, the AP 11 saving therein the cached information may be or not the same AP 11 as that transferred the information acquisition request. In the case of the same AP, response instruction is generated, and in the case of the different AP, the proxy response instruction or the transfer instruction is generated. Each instruction is sent via the TCP/IP processor 124, the transfer detector 123, and the wired interface 121 to the destination AP 11.

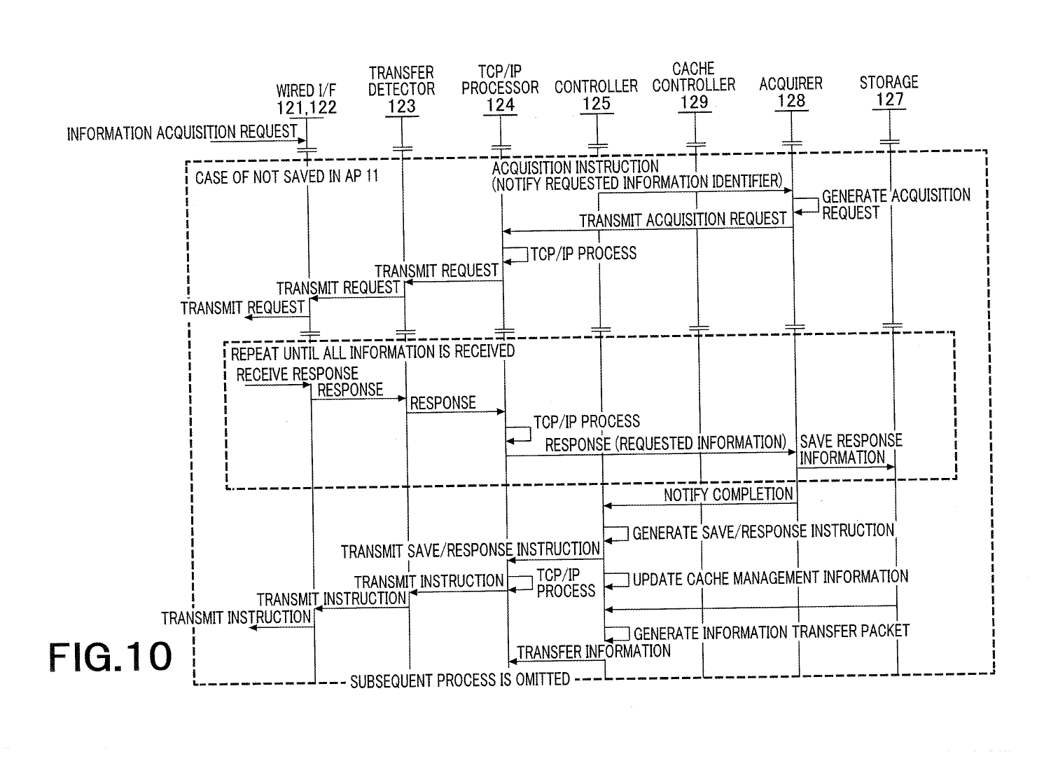

FIG. 10 is a diagram showing another example of the operational sequence of the WLC according to the first embodiment. FIG. 10 show a case where no AP 11 saves therein the required cache. The process is the same as that in FIG. 9 from acquisition of the information acquisition request by the wired interface 121 to acquisition by the controller 125 of the determination result of whether or not the information is cached, and the description thereof is omitted.

If the controller 125 obtains the determination result that the cached information is not saved, it instructs the acquirer 128 to acquire the requested information. At this occasion, the controller 125 notifies the extracted requested information identifier to the acquirer 128. The acquirer 128 generates a request in the same form as in the case where the wireless communication terminal 13 transmits the request to the web server 31. The TCP/IP processor 124 performs the transmission process for the generated request. This request is transmitted through the transfer detector 123 and the wired interface 122. Note that FIG. 10 illustrates the wired interfaces 121 and 122 by the same line for convenience sake. The response, inversely to the case of the transmission, goes through the wired interface 122, the transfer detector 123, and the TCP/IP processor 124, and the acquirer 128 receives the requested information to save in the storage 127. Note that the save destination may be a mass storage not shown.

When all the requested information is acquired, the acquirer 128 notifies completion of acquisition to controller 125. The controller 125 generates a response for instruction of saving the acquired information and transmitting it to the wireless communication terminal 13. The response is subjected to the transmission process by the TCP/IP processor 124 and transmitted via the transfer detector 123 and the wired interface 122. The controller 125 also acquires information from the storage 127 to generate an information transfer packet. The information transfer packet is also subjected to the transmission process by the TCP/IP processor 124 and transmitted via the transfer detector 123 and the wired interface 122. Note that, here, the controller 125 get started to generate the information transfer packet after generating the response, but may start to generate them at the same time.

Additionally, the controller 125 updates the cache management information by recording in the storage 127 that the AP 11 holds the information specified by the requested information identifier. In the case where the information has the expiration time, the controller 125 records the information in the form with the expiration time. This update may be also made after the notification is received that the AP 11 has normally received the cached information. The above description is of the operational sequence of the WLC 12 in the first embodiment.

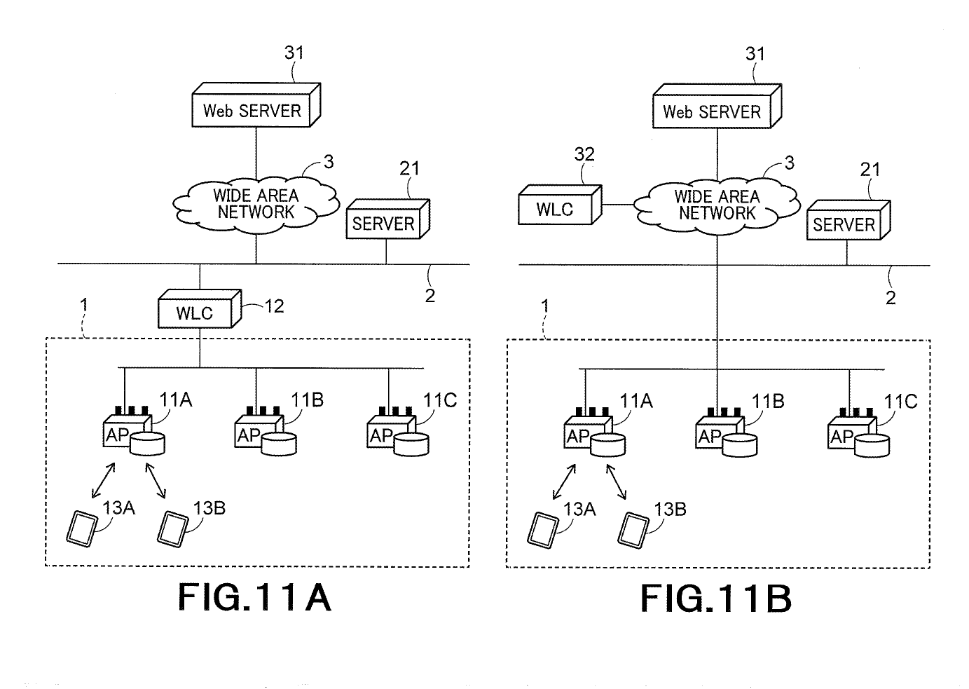

Note that the configuration of the wireless communication system in the first embodiment may be different from that shown in FIG. 1. FIGS. 11A and 11B are each a diagram showing another example of the communication environment in the wireless communication system according to the first embodiment. In the wireless communication system shown in FIG. 11A, a new external server 21 providing the cache function is connected with the network 2. The external server 21 includes, in place of the WLC 12, the cache controller 129 and the acquirer 128, and thus, the processes performed by the cache controller 129 and acquirer 128 are performed by the external server 21. The information exchanging and instruction sending performed between the controller 125 and the cache controller 129 may be performed by use of a communication protocol including an application protocol such as the TCP/IP or HTTP. In this case, the processing load on the WLC 12 can be distributed.

In the wireless communication system shown in FIG. 11B, the WLC 12 is not included, and a WLC 32 is provided on another network connected with the wide area network 3, differently from the configuration shown in FIG. 11A. The WLC 12 manages the AP 11 existing on the network 1, but the WLC 32 may be considered to be used in a case where the APs on the plural networks are collectively managed. The network in which the

WLC 32 exists may be a cloud network provided by a cloud provider. The communication with the wireless communication terminal 13 is the same except that the destination of the communication is WLC 32 instead of the WLC 12.

The external server 21 includes, in place of the WLC 12, the cache controller 129 and the acquirer 128 similarly in FIG. 11A. Therefore, the WLC 32, differently from the WLC 12, does not include the cache controller 129 and the acquirer 128. The WLC 32 does not include the transfer detector 123 because the all packets acquired by the WLC 32 are the packets to process. This reduces the processing load put on the WLC 32 as compared with the WLC 12. The external server 21 may be located on another network connected with the wide area network 3 such as the cloud network, but not shown in the figure. If the external server 21 is a cloud server provided by a cloud provider, a cloud service may be used to flexibility extend the storage capacity each time.

Note that in the description herein, the description for the WLC 12 may be replaced with those for the WLC 32 or server 21 unless otherwise specifically described.

As described above, according to the first embodiment, the content can be provided more promptly by the AP having the storage as compared to sending from the web server. Further, a complex function required for attaining the cache function such as the packet scanning is performed by the WLC 12 or another server on the network. This can give an effect of the cache as well as prevent the function held by the AP from being complexed to suppress increase in the power consumption, heat generation amount or the like.

### Second Embodiment

In the first embodiment, the AP 11 does not perform the packet scanning process or the like in order to reduce the load put on the AP 11 as much as possible, but in the second embodiment, the AP 11 performs the packet scanning. As a result of this, the processing load put on each AP 11 increases, but the load due to the WLC 12 scanning the requesting packets from the all APs 11 can be reduced to smooth the loads put on the entire system.

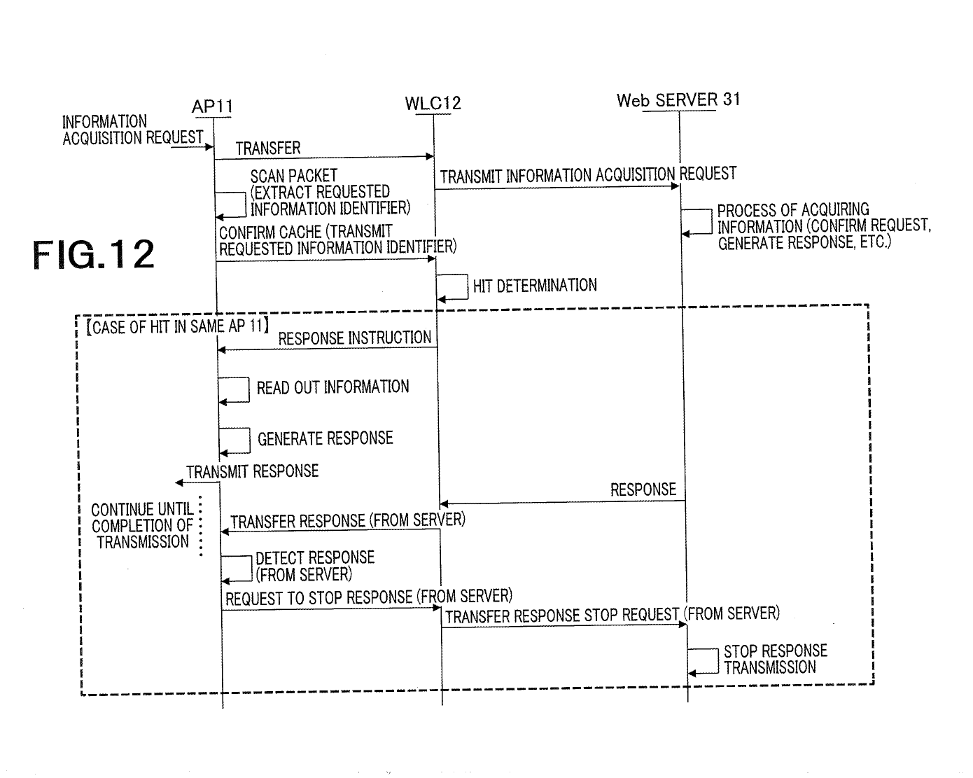

FIG. 12 is a diagram showing an example of a communication sequence of a wireless communication system according to a second embodiment. FIG. 12 shows a case where the desired information is saved in AP 11 transferring the request.

The AP 11 performs the packet scanning and a cache confirmation request to the WLC 12 after transferring the information acquisition request from the wireless communication terminal 13 to the WLC 12, which is different from the first embodiment. The cache confirmation request contains the requested information identifier extracted by the packet scanning.

The WLC 12 does not perform the packet scanning on the packets from the AP 11 which is performed in the first embodiment. Therefore, differently from the first embodiment, the WLC 12 transfers the information acquisition request as it is to the web server 31 that is the destination of the information acquisition request. Note that the packets from the web server 31 is subjected to the packet scanning, as described later. The condition for determining the packets to be subjected to the packet scanning may be attained by setting a rule different from in the first embodiment in the storage 127 to make the transfer detector 123 to refer thereto, or may be fixedly set in the transfer detector 123.

When the WLC 12 receives the cache confirmation request from the AP 11, the WLC 12 performs the hit determination on the basis of the requested information identifier contained in the cache confirmation request. The response instruction is notified to the AP 11 after the hit determination. The process that AP 11 transmits the response to the wireless communication terminal 13 on the basis of the notified information is the same as in the first embodiment.

When receiving the information acquisition request, the web server 31 returns the response. The AP 11 receiving the response transmitted via the WLC 12 requests the web server 31 to stop the response. Note that if the network bandwidth or the like is not taken into account, the received response may be merely discarded.

The request for stop the response is sent via the WLC 12 to the web server 31, and then, the web server 31 stops the transmission of response. Note that detection of the response from the web server 31 and sending the request for stop the response may be performed by the WLC 12.

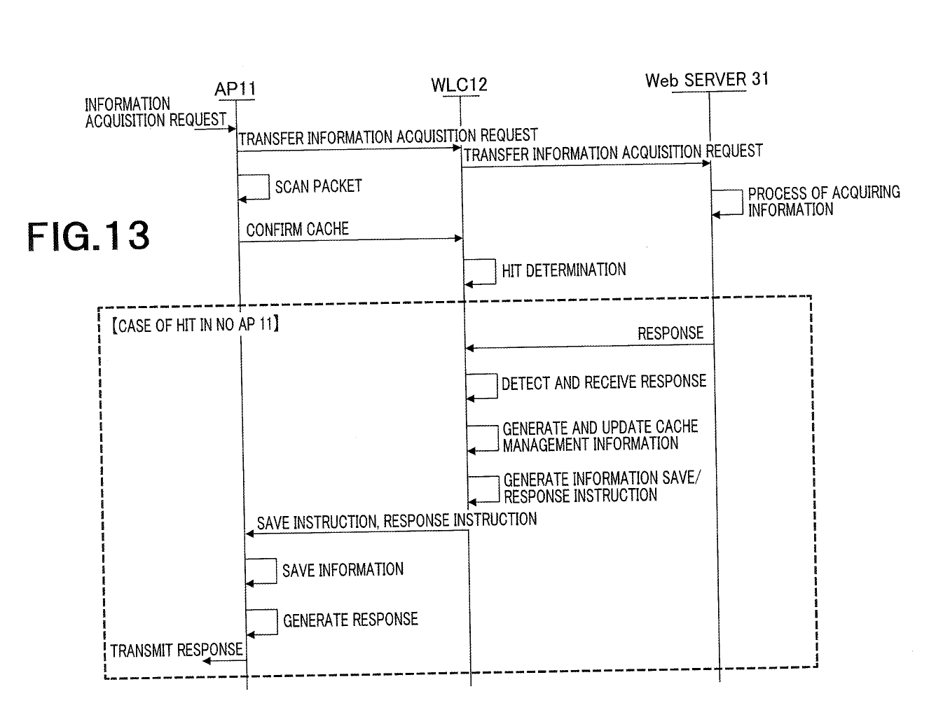

FIG. 13 is a diagram showing another example of the communication sequence of the wireless communication system according to the second embodiment. FIG. 13 show a case where no AP 11 saves therein the desired information.

The process from when the AP 11 receives the information acquisition request from the wireless communication terminal 13 until the WLC 12 performs the hit determination is the same as in FIG. 12. If the hit determination finds that no AP 11 saves therein the cache, the WLC 12 detects the response from the web server 31 to perform the reception process by the TCP/IP processor 124. As a result of the reception process, the information requested by the wireless communication terminal 13 is obtained, and the cache management information is updated by that information. This update process is the same as in the first embodiment. After that, the WLC 12 gives the AP 11 the save instruction and the response instruction with respect to the wireless communication terminal 13. Subsequent processes are the same as in the first embodiment and a description thereof is omitted.

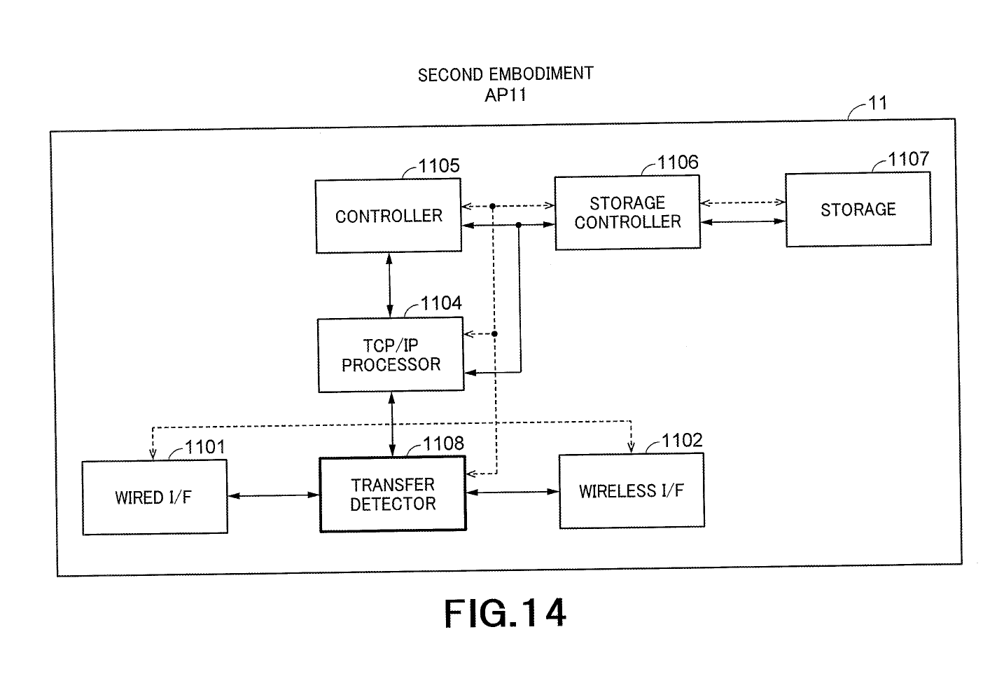

FIG. 14 is a block diagram showing a schematic configuration of the AP 11 according to the second embodiment. The AP 11 according to the second embodiment includes a transfer detector 1108 in place of the transferer 1103 in the AP 11 according to the first embodiment.

The transfer detector 1108 performs the packet scanning for the packets from the wireless communication terminal 13.

The transfer detector 1108 may extracts the packets only probably containing the requested information identifier from the all packets, and may further extract the requested information identifier from the extracted packets. If the transfer detector 1108 does not extract the requested information identifier, the controller 1105 scans the packets extracted by transfer detector 1108 to extract the requested information identifier. The AP 11 may perform the packet scanning for the acquired packets. The AP 11 may copy the packets and perform the packet scanning for the copied packets in order to immediately transfer the acquired packets to the WLC 12.

The transfer detector 1108 also performs the packet scanning for the packets from the web server 31 or the like to detect the response. This is done in order to stop the transmission of response from the web server 31, in the case of the information corresponding to the information acquisition request was already sent from the cache of the AP 11, when a corresponding response is sent from the web server 31. A message instructing to stop is generated by the controller 125. The message is subjected to the transmission process by the TCP/IP processor 124 to be transmitted to the web server 31. The message instructing to stop can be attained, for example, by use of a packet in which a RST (Reset) flag of the TCP is set. Other components are the same as in the first embodiment and a description thereof is omitted.

The configuration of the WLC 12 in the second embodiment is the same as in the first embodiment. However, the packet detected by the transfer detector 123 is different. In the first embodiment, the information acquisition request is detected from the packets transferred from the AP 11. On the other hand, in the second embodiment, the response is detected from the packets sent from the web server 31. More specifically, the response is detected from the packets regarding the response from the web server 31 with respect to the requested information identifier contained in a message of “cache confirmation” which is transmitted from the AP 11. However, if the AP 11 requires the web server 31 to stop the response as described above, that is, if a cache confirmation result is that the hit determination is true, the WLC 12 may not necessarily perform the extraction. If the response is detected, the acquirer 128 receives the extracted response from the web server 31 to save in the storage 127, similarly in the first embodiment. The processes for other components are the same as in the first embodiment and a description thereof is omitted.

As described above, according to the second embodiment, the packet scanning performed intensively by the WLC 12 is shared with the AP 11 while maintaining a merit of the AP 11 having the storage mounted thereon, which affords distribution of the load put on the entire system.

### Third Embodiment

Subsequently, a description is given of a third embodiment. In the third embodiment, each AP 11 also performs the hit determination on whether or not its storage 1107 stores the cached information therein. This eliminates the need to exchange the requested information or the like via the network in a case where the AP 11 directly connects with the wireless communication terminal 13 requesting the information and the AP 11 caches the information. Thereby, the response can be acquired with less delay.

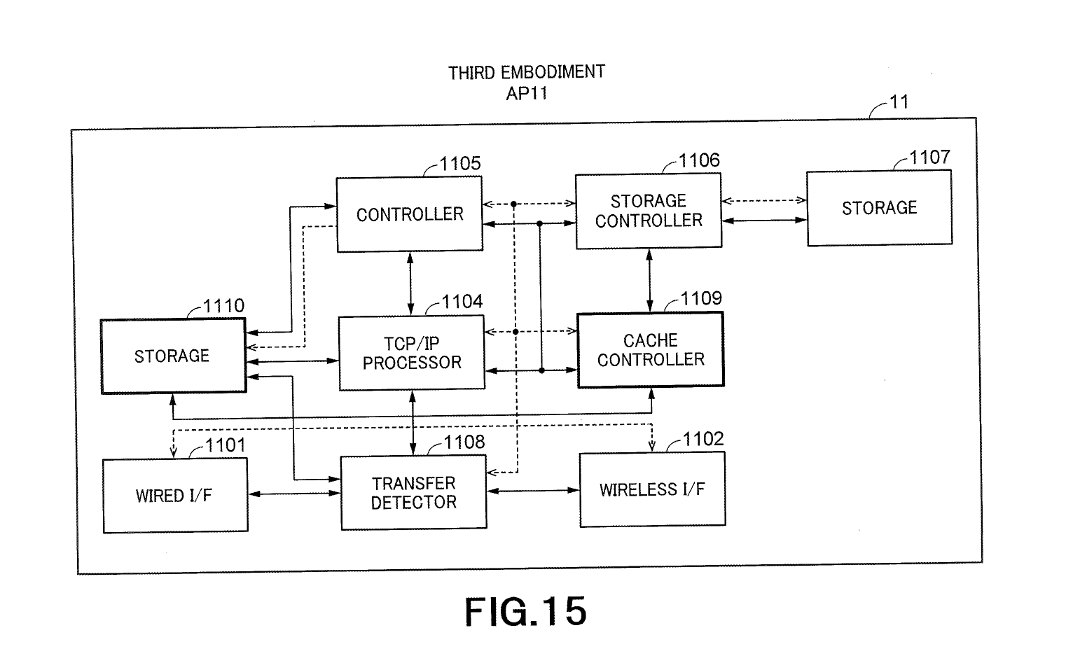

FIG. 15 is a block diagram showing a schematic configuration of the AP 11 according to the third embodiment. The AP 11 according to the third embodiment further includes a cache controller 1109 and a storage 1110 in addition to the AP 11 according to the second embodiment.

The cache controller 1109 determines whether or not the information of target is held in the storage 1107 on the basis of the cache management information for managing the cache stored in the storage 1107 and the requested information identifier extracted from the packets. The storage 1110 holds the relevant cache management information. The cache management information may be the same as the cache management information held by the WLC 21 in the above embodiments as shown in FIG. 8. However, each AP 11 targets only the cache stored in its storage 1107, and thus, the item of the AP may not be necessarily needed. However, in a case where the APs 11 act in concert with each other to share the content of the cache with each other, the cache management information is the same as those in the above embodiments.

If the APs 11 act in concert with each other, every time an entry of the cache management information is updated, the updated information may be transmitted to the network 1 by way of broadcast, for example. Alternatively, a multicast group to which the APs 11 are registered as members is formed such that the updated information may be transmitted to an address of the multicast group by way of multicast. Alternatively, the updated information may be separately transmitted to the respective APs 11 by way of unicast. A frequency of message transmission may be determined freely. The message may be transmitted every time updated, periodically at every certain time period, or irregularly such as when the number of times of updating exceeds a predetermined number. Other components are the same as in the second embodiment and a description thereof is omitted.

If the cache is held in the AP 11, the response is transmitted to the wireless communication terminal 13. If the cache is not held in the AP 11, the WLC 12 or the web server 31 is required to acquire the information. The response from the WLC 12 or the web server 31 is saved in the storage 1107, and the response is transmitted to the wireless communication terminal 13 requesting the information. These processes may be performed by the controller 1105 or by the cache controller 1109.

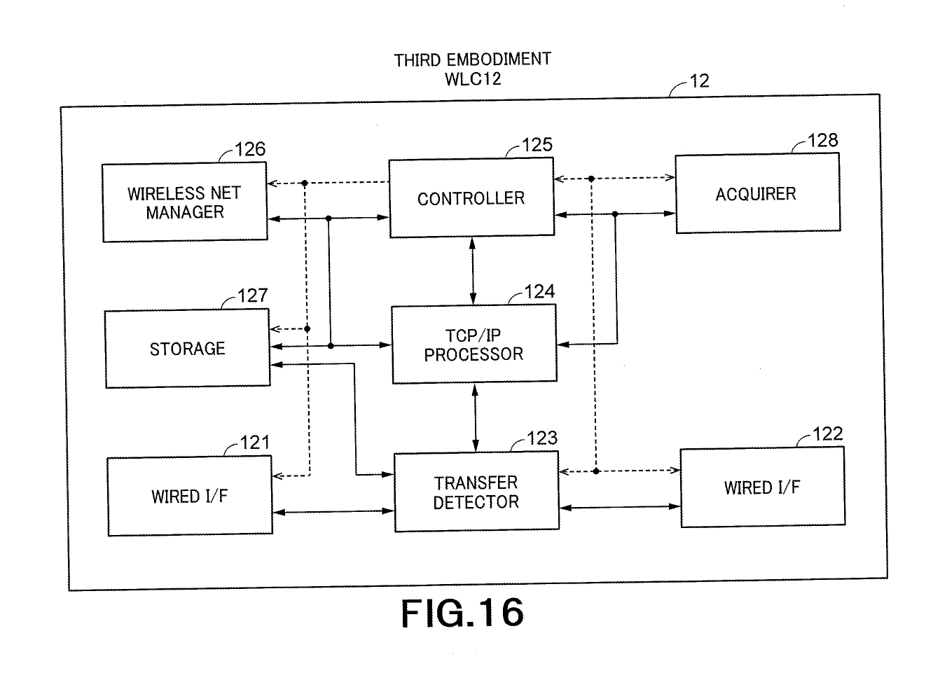

FIG. 16 is a block diagram showing a schematic configuration of the WLC 12 according to the third embodiment. There can be two types of configuration of the WLC 12 according to the third embodiment. One is the same configuration as the first and second embodiments in which the WLC 12 holds the cache management information for the APs 11. In this configuration, the WLC 12 manages the cache of a plurality of APs 11 under its control to reduce the cache duplicated between the APs 11, for example, allowing a distributed cache system to be configured. The other is a configuration in which the load put on the WLC 12 is reduced and the cache controller 129 for managing the cache management information is eliminated. FIG. 16 shows the latter configuration. Other configurations and processes are the same as in the first and second embodiments.

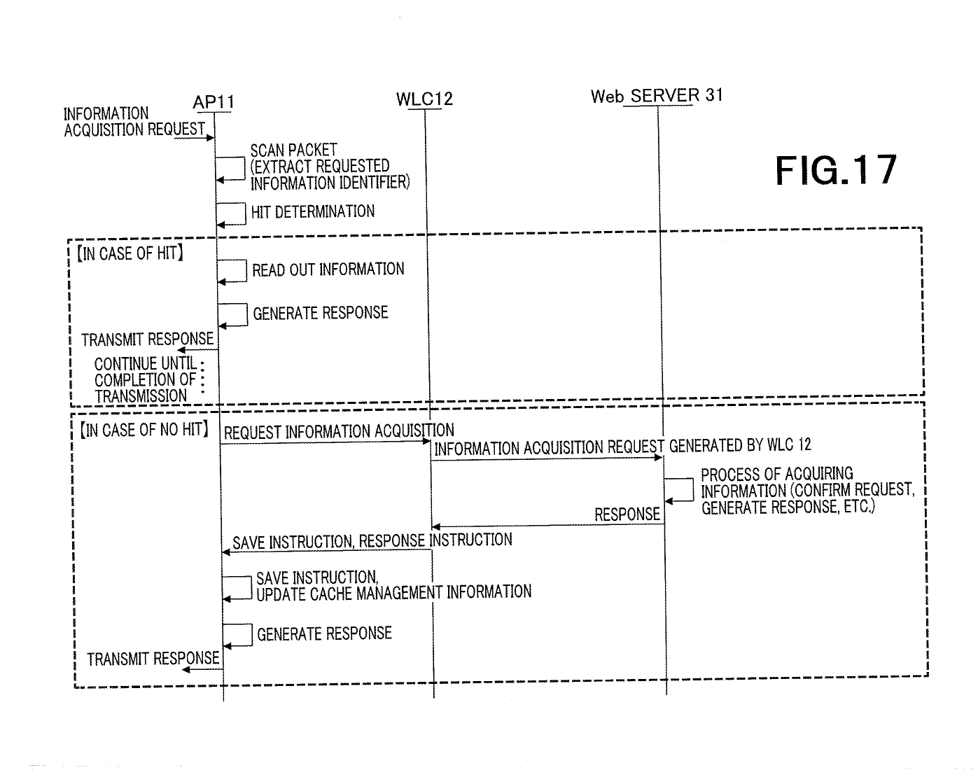

FIG. 17 is a diagram showing an example of a communication sequence of the wireless communication system according to the third embodiment. In the third embodiment, many processes are performed by the AP 11. The AP receives the packets transmitted by the wireless communication terminal 13, scans the packets, and extracts the information acquisition request and the requested information identifier. After that, the AP performs the hit determination by use of the requested information identifier. The subsequent processes are different depending on whether or not the storage 1107 of the AP 11 contains the same information (hit or not). If the hit determination is true, the AP 11 reads out the information of target from its storage 1107 and generates the response. After that, the response is returned to the wireless communication terminal 13. If the hit determination is false, the controller 1105 or the cache controller 1109 requests the information requested by the wireless communication terminal 13 to the WLC 12.

The WLC 12 communicates with the web server 31 on the basis of the request from the AP 11 to acquire the information of target. The WLC 12 transitorily stores the acquired information in the storage 127 or the like. The WLC 12 gives the request source AP 11 the save instruction and the response instruction after acquiring all responses from the server.

When receiving the save instruction and the response instruction, the request source AP 11 saves the information in the storage 1107 and updates the cache management information for managing the cache, and thereafter, returns the response to the wireless communication terminal 13.

The information acquired by the WLC 12 is not limited to the information requested by the AP 11. Information to be newly requested may be anticipatively acquired on the basis of the requested information before requested by the AP 11, such as an image file and a script file which are embedded in a web page requested, for example. Further, a web page linked, information embedded in the relevant web page, and the like may be anticipatively acquired. Thereby, the AP 11 does not have to wait until the WLC 12 acquires the information from the web server 31 when requesting additional information acquisition. Therefore, AP 11 can immediately acquire the information from the WLC 12.

Additionally, an acquisition tendency may be grasped from a history (log) of the information or the like acquired by the WLC 12 such that related information is identified on the basis of the acquisition tendency and the identified information is additionally acquired. For example, it may be considered that a periodically viewed website is grasped from the history information to acquire the information of the relevant website anticipatively. This probably allows the AP 11 to immediately acquire the information from the WLC 12 even when a new information acquisition request comes. This history information may include information concerning the user. For example, information may be included which identifies the user, such as a user name, a subscriber's number, an identifier for utilizing the wireless LAN system or other communication system other than the wireless LAN. Alternatively, information may be included which does not identify the user but indicates only the attribute, such as an age, sex, postal code, part of address, occupation, location information of the wireless communication terminal 13, radiowave intensity of the wireless communication terminal and the like. Moreover, an amount of the information anticipatively acquired such as the number of links to be traced, and kinds of information to acquire may also be determined based on the acquisition tendency.

The history information may be actively or passively acquired by the AP 11 from the wireless communication terminal 13.

For example, the history information may be determined to be transmitted to the AP 11 by the wireless communication terminal 13 when the wireless communication terminal 13 connects to the AP 11. Alternatively, the AP 11 may regularly or irregularly collect the history information from the wireless communication terminal 13 under its control. The AP 11 may transmit the history information acquired in this way, together with information acquisition request, to the WLC 12. Alternatively, the WLC 12 may collect the information directly from the wireless communication terminal 13 or may utilize the log information which the WLC 12 has.

Note that the process of anticipatively acquiring as described above may not be limited to the third embodiment, and may be performed also by the acquirer 128 in the WLC 12 in the other embodiments. However, in other embodiments, the WLC 12 performs the process not performed in the third embodiment such as the packet scanning or the hit determination, and thus, the WLC 12 should be designed taking into account the load rising.

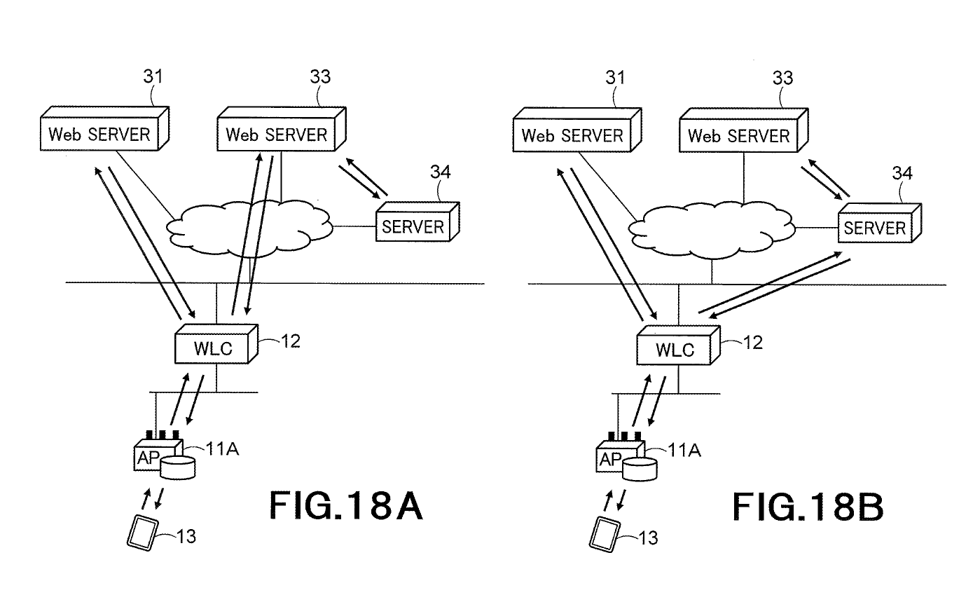

The WLC 12 may be configured to only acquire the information from the web server 31 such that grasping the acquisition tendency. In this case, identifying the related information described above may be performed by a further external server. FIGS. 18A and 18B are each a diagram showing an example of a configuration in which an external server acquires pertinent information. In FIG. 18A, the WLC 12 grasps the acquisition tendency and identifies the related information. The acquisition request from the wireless communication terminal 13 is sent via the AP 11 to the WLC 12. The WLC 12 acquires the response information from the web server 31 on the basis of the acquisition request. Further, the WLC 12 grasps the acquisition tendency and identifies the related information to acquire the pertinent information from a web server 33 different from the web server 31. The acquired response information and pertinent information are sent from the WLC 12 via the AP 11 to the wireless communication terminal 13.

On the other hand, in FIG. 18B, an external server 34 grasps the acquisition tendency and identifies the related information. The process until the response information is acquired is the same as in FIG. 18A. Furthermore, the WLC 12 sends the acquisition request also to the external server 34, and the external server 34 identifies the related information from the acquisition request. Alternatively, the WLC 12 may identify the related information and then transmit the acquisition request with respect to the pertinent information to the external server 34. The external server 34 transmits the pertinent information acquired from the web server 33 to the WLC 12. The WLC 12 instructs the AP 11 to save the acquired information. These roles may be determined taking into account the load put on the WLC 12, security such as authentication, availability of the system and the like. In the case of FIG. 18B, the WLC 12 transmits and receives the information to and from only one external server 34 without accessing plural servers. Thereby, the WLC 12 aquires information efficiently.

As describe above, according to the third embodiment, the response can be obtained with less delay if the information desired by the wireless communication terminal 13 is cached in the connected AP 11, while achieving the merit of the AP 11 having the storage mounted thereon and the distribution of the load put on the entire system described in the second embodiment. However, the load put on the AP is presumed to rise as compared with the first and second embodiments, and thus, the AP should be designed taking into account the load rising.

### Fourth Embodiment

In a fourth embodiment, the AP 11 is configured to acquire the content from the web server 31 and the WLC 12 is configured to perform the packet scanning and the hit determination as in the first embodiment, but not perform the content acquisition. This allows the WLC 12 not to transitorily acquire and save the cache, which distributes the load put on the entire system.

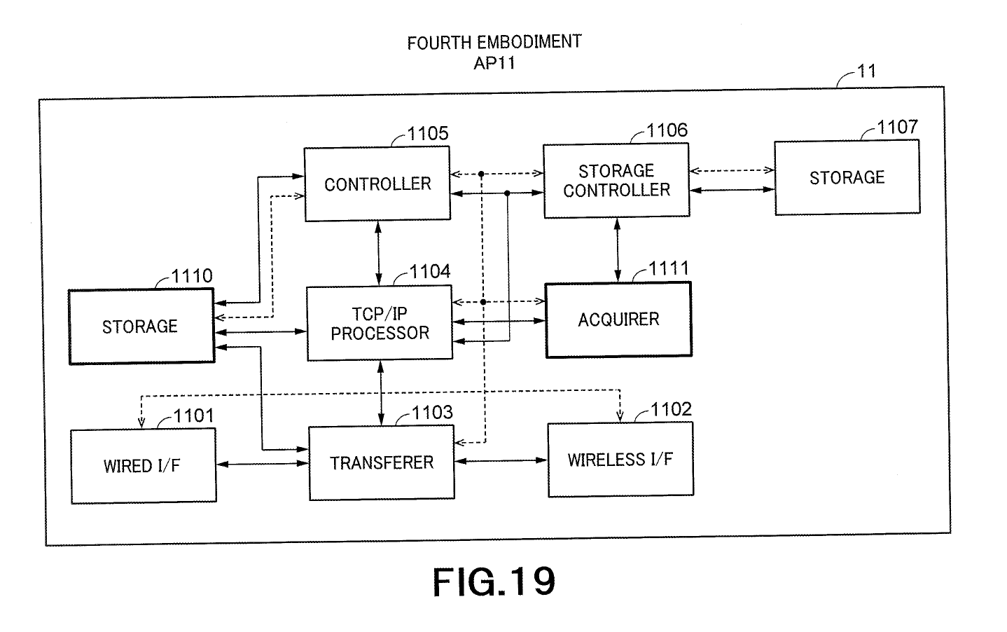

FIG. 19 is a block diagram showing a schematic configuration of the AP 11 according to the fourth embodiment. The AP 11 in the fourth embodiment further includes an acquirer 1111 which is not included in the above embodiments.

Note that since the packet scanning is not performed, not the transfer detector 1108 in the third embodiment but the transferer 1103 is connected as in the first and second embodiments. However, the transfer detector 1108 may merely not perform detection.

The acquirer 1111 acquires the information from the web server 31. The acquirer 1111 is connected to the TCP/IP processor 1104 and the storage controller 1106. The communication by the acquirer 1111 is processed by the TCP/IP processor 1104 and performed via the interfaces 1101 and 1102.

The information acquired by the acquirer 1111 is saved via the storage controller 1106 in the storage 1107. The saved information is used as the cache. The wireless communication terminal 13 as the transmission destination and the information to be transmitted are instructed by the WLC 12. If the instruction is given, the controller 1105 reads out the instructed information and transmits to the instructed wireless communication terminal 13.

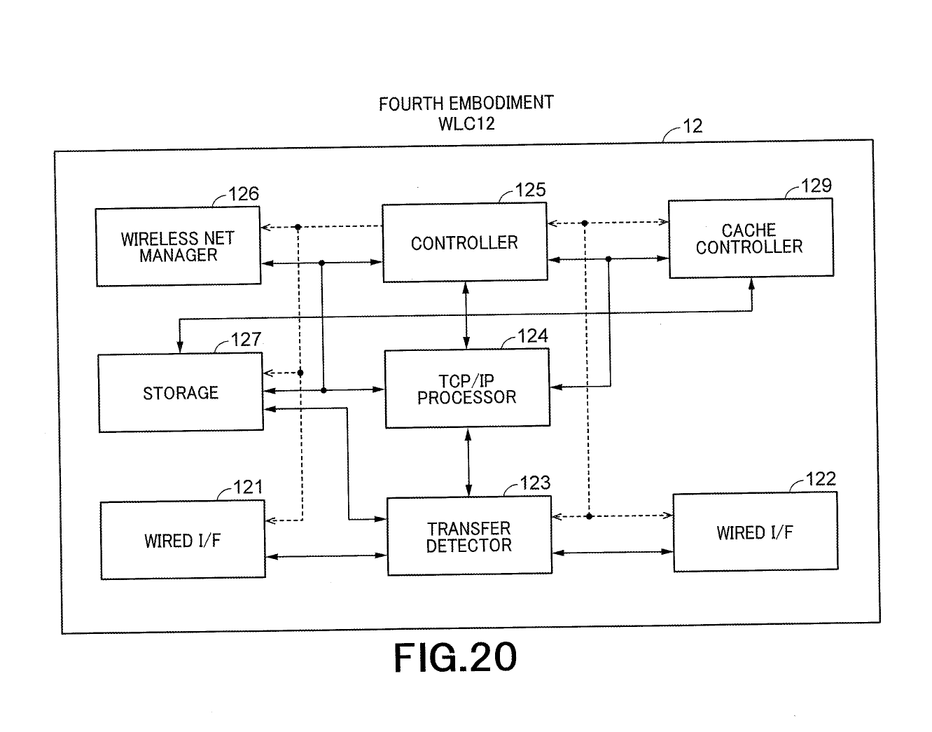

FIG. 20 is a block diagram showing a schematic configuration of the WLC 12 according to the fourth embodiment. In the fourth embodiment, the acquirer 128 is not included which is included in the first to third embodiments, and the cache controller 129 is included which is included in the first and second embodiments but is not included in the third embodiment.

The WLC 12 performs the packet scanning at the transfer detector 123 or the controller 125. If the transfer detector 123 performs the packet scanning, the process of the TCP/IP and application protocol is not performed and the requested information identifier is extracted on the basis of a specific area extracted by a method such as pattern matching. If the controller 125 performs the packet scanning, the TCP/IP processor 124 and the controller 125 acquire the information of an application layer, and the controller 125 extracts the requested information identifier by analyzing the information of the application layer.

The cache controller 129 manages the cached information stored in the storage 1107 of each AP 11 under the control of the WLC 12 as is in the first and second embodiments. The cache management information required for managing the cache is also stored in the storage 127 in a form as in FIG. 11 as is in the first and second embodiments. The controller 125 controls the cache controller 129 to confirm whether or not the requested information is saved in the cache. Then, the controller 125 determines processing details depending on a result of the confirmation.

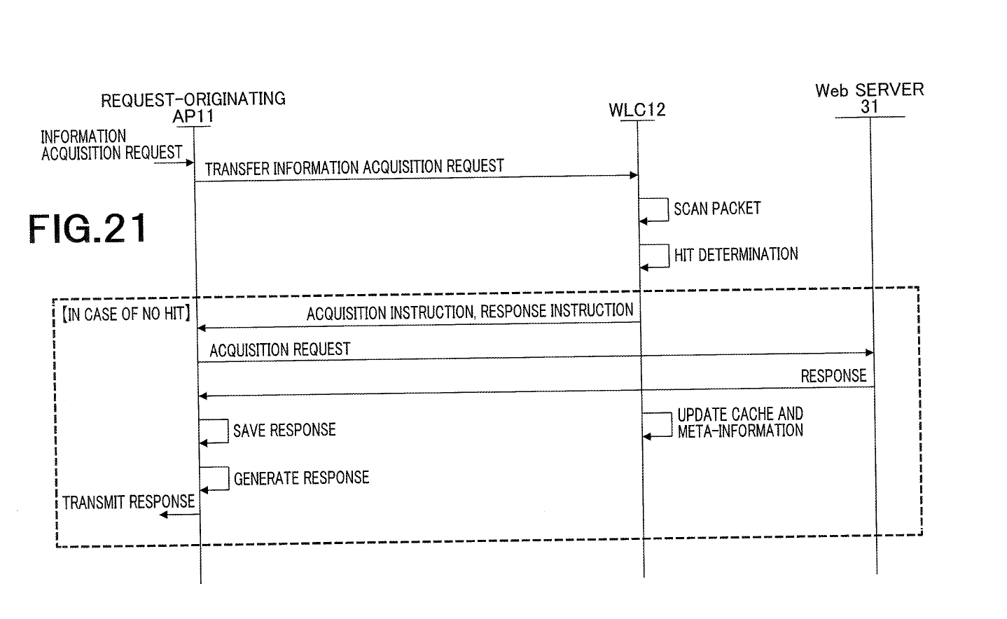

FIG. 21 is a diagram showing an example of a communication sequence of the wireless communication system according to the fourth embodiment. Here is shown the case where the requested information is not cached in any AP 11. The case where the requested information is determined to be cached in any AP 11, the process is the same as the directly responding or after-transfer responding according to the first embodiment shown in the FIG. 3, and a description there of is omitted.

The request source AP 11 transfers the packets received from the wireless communication terminal 13 to the WLC 12.

The WLC 12 scans the packets transferred to extract the requested information identifier. The extracted requested information identifier is compared with the cache management information to confirm whether or not the information of target is cached in the AP 11 under the control of the WLC 12. If the WLC 12 determines that the cache of any AP 11 does not hit, it instructs the request source AP 11 to acquire the information and transmit the response to the wireless communication terminal 13 transmitting the request. Similarly to the first embodiment, the cache controller 129 updates the cache management information.

The request source AP 11 instructed by the WLC 12 to acquire the information and transmit the response transmits the information acquisition request to the web server 31 to acquire the information. After acquiring the information, the acquired information is saved in the storage of the relevant AP 11 and the response is transmitted to the wireless communication terminal 13, similarly to the above embodiments.

As described above, according to the fourth embodiment, the selected AP 11 directly performs the content acquisition, which eliminates the need for the WLC 12 to include the acquirer and to transitorily store the cached information. This can smooth the processing loads put on the entire system.

### Fifth Embodiment

In the above embodiments, the request source AP 11 or the AP 11 having the cache return the response to the wireless communication terminal 13. However, it is not necessarily appropriate that the AP 11 acquiring the information acquisition request responds. For example, there may be a case where receiving the response from the AP 11B faster than from the AP 11A to which the acquisition request is sent in terms of a load status of the AP 11A, the wireless communication terminal 13 moving, or the like.

Therefore, in a fifth embodiment, the AP 11 to respond is decided.

The fifth embodiment may be the same as the above first to fourth embodiments except for deciding the AP 11 to respond (AP determination). The decision is assumed to be made by the controller 125 or cache controller 129 in the WLC 12. However, if the APs 11 act in concert with each other, the decision may be made by the controller 1105 in the AP 11.

A description is given of a method of selecting AP 11 which is to save therein the requested information. A first method is a method of fixedly selecting the request source AP. This method has an advantage that the delay until the wireless communication terminal 13 acquires the information, the process of taking over the communication or the like does not occur because the request source AP inevitably coincides with the transmission source AP unless the wireless communication terminal 13 moves. However, in a case such as where many wireless communication terminals 13 utilizes a certain AP 11, a large amount of information is accumulated in the storage of the relevant AP 11, causing problems of a storage space, the processing load put on the AP, and the like.

A second method is a method of selecting the AP 11 which is to save on the basis of an order of priority. A parameter for determining the order of priority may be determined freely. One parameter or a combination of plural parameters may be used.

The parameter may be information concerning a condition of the AP 11, for example, information concerning the load put on the AP 11, including a free space of the storage 1107 of each AP 11, a traffic processed by each AP 11, the number of the wireless communication terminals connected with each AP 11, and the wireless area range provided by each AP 11. Information concerning the communication of the AP 11 may be included, such as a communication state between the WLC 12 and each AP 11, and a communication state between the wireless communication terminal 13 receiving the response and each AP 11, for example. Examples of the communication state include a link rate, an SNR (Signal to Noise Ratio), a PER (Packet Error Rate), an RSSI (Received Signal Strength Indicator), a wireless radiowave frequency, a usage rate, and an IP level throughput. Further, there may be included change rates or time series information of changes of these. Besides, those concerning the information to transmit may be included such as a type of information such as a text, a data size of information, for example.

For example, if the link rate between the wireless communication terminal 13 and the request source AP 11 is low or if the PER is high, such a disadvantage is likely to occur that a long time is taken until completion of transmitting the cached information. Therefore, a determination is made on whether or not there exists AP 11 can communicate with the wireless communication terminal 13 in a better environment of communication.

The AP 11 well connectable may be decided regardless of whether or not it caches the requested information, or the AP 11 caching may be preferentially selected.

The parameter may utilize the information collected by the WLC 12 for managing the AP 11, or may be newly collected. A frequency of collecting the parameter may be determined freely. The collection may be performed periodically at a predetermined collection interval such as in the wireless LAN standard, or may be collected at a different interval or irregularly. A process of deciding the priority on the basis of the collected parameters may be performed for each parameter collection. Alternatively, the process may be performed at a certain time period interval determined in advance such as every one hour, for example. Alternatively, the process may be performed immediately before or after a time zone which is divided by time zones where the wireless communication terminal 13 is used such as a going-to-work time zone, a lunch break, a leaving-work time zone, a business time zone and the like. For example, if the priority in the lunch break is changed, it may be considered that the priority on the specific AP 11 may rise which has a provision range such as an eating facility area where many peoples gather at the lunch break but a usage frequency is lower in other time zones than the lunch break.

A third method is a method of deciding at random. A fourth method is a method of deciding by a round-robin scheme. In the round-robin scheme, the information is saved in accordance with a predetermined order. This order may be considered to be an order in which the WLC 12 recognizes the AP 11, an order of identifiers for the AP 11 such as a MAC address, an IP address, and a host name, an initial capacity (maximum capacity) of the storage 1107, and the like.

A fifth method is a method of using a hash value on the basis of the requested information identifier. The WLC 12 applies a hash algorithm to the received requested information identifier to decide the AP 11 which is to cache on the basis of the calculated hash value.

A sixth method is a method of deciding the AP which is to save depending on a type of the information to save. For example, the information in a text format is saved in the AP which is to save the information in a text format and the information of moving picture is saved in the AP which is to save the information of moving picture. The type of the information to save may be determined depending on a capacity, type and performance of the storage included in the AP 11. For example, in a case where the AP 11A has a high-capacity storage, but the AP 11B has a low-capacity storage, it may be fixedly determined that the AP 11A saves the moving picture therein and the AP 11B saves the text information therein.

Inversely, in order that the load is not concentrated on the specific storage, the information type, an average data size of the data and the like held in the APs 11 may be distributed. For example, since the moving picture generally has the data size larger than the text, a higher transmission load is put on the AP 11 accumulating only the moving picture information than on the AP 11 accumulating only the text information. Therefore, if an AP 11 already saves the moving picture therein, another AP 11 which does not save the moving picture therein may save.

Note that the wireless area provided by each AP 11 may be known in advance by the information on the storage capacity, radiowave intensity (RSSI strength), communication state and the like of each AP 11. In a case where the wireless communication terminal 13 does not exist in the wireless area provided by the AP 11, the priority on the relevant AP 11 may be set to be minimum. Note that this provided wireless area may be changed by the above second method or the like.

If the AP 11 decided by the above series of methods cannot save, for example, in a case such as where the free space of the storage of the relevant AP 11 lacks, selection is retried. Finally, if no AP 11 cannot save, a predetermined cache replacement algorithm is performed to replace the cached information with the information to save.

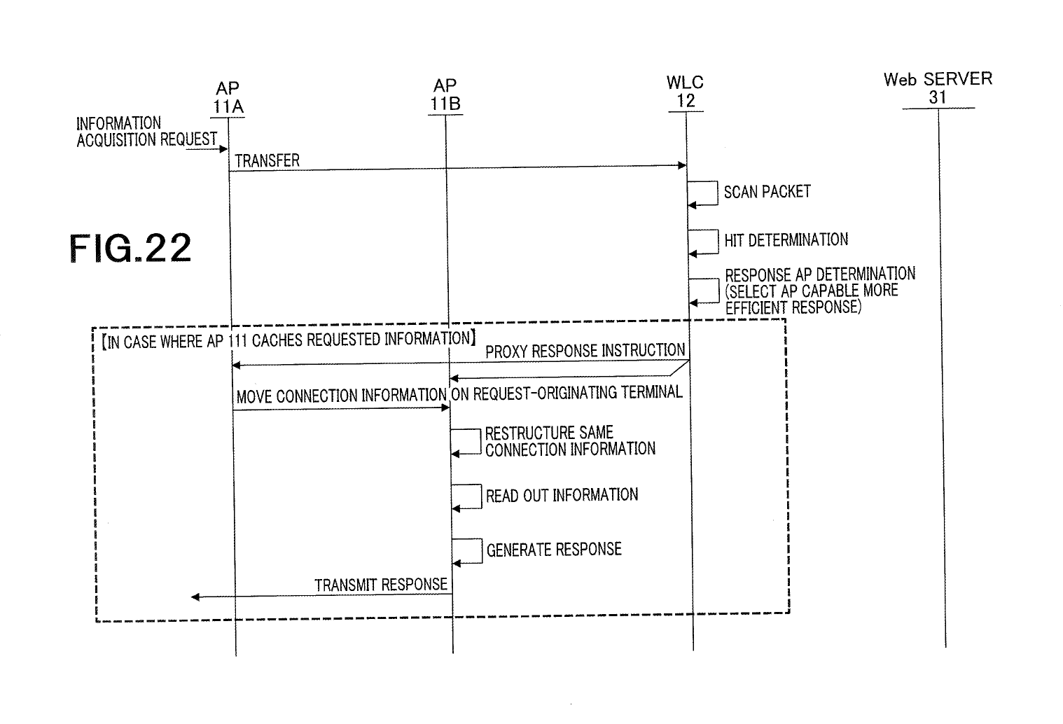

FIG. 22 is a diagram showing an example of a communication sequence of the wireless communication system according to the fifth embodiment. Here, assume that a configuration the same as in the first embodiment is used and the packet scanning and the hit determination are performed by the WLC 12. The process from when the AP 11 receives the acquisition request from the wireless communication terminal 13 until the WLC 12 performs the hit determination is the same as in the first embodiment.

In this hit determination, if the plural of APs 11 hold the requested information, the plural of requested information may be extracted.

The WLC 12 adequately grasps a state of the wireless communication between each AP 11 and the wireless communication terminal 13. It may be determined whether or not the AP 11 with which the wireless communication terminal 13 currently connects is suitable for the information transmission. This determination process may be performed by the controller 125 or the wireless network manager 126.

A method for the above determination may be fixedly set in the component which performs the determination process or may be saved in the storage 127 so as to be referred to in performing the determination. The determination method to be used may be one or more.

In a case where there is another AP 11 communicable under a good condition (assuming the AP 11B) and the information is cached in the AP 11B, the WLC 12 instructs the request source AP 11A and the new connection destination AP 11B to change over the connection of the wireless communication terminal 13 and transmit a response regarding the requested information, similarly to the directly responding in the first embodiment. Subsequent processes are also the same as the directly responding in the first embodiment.

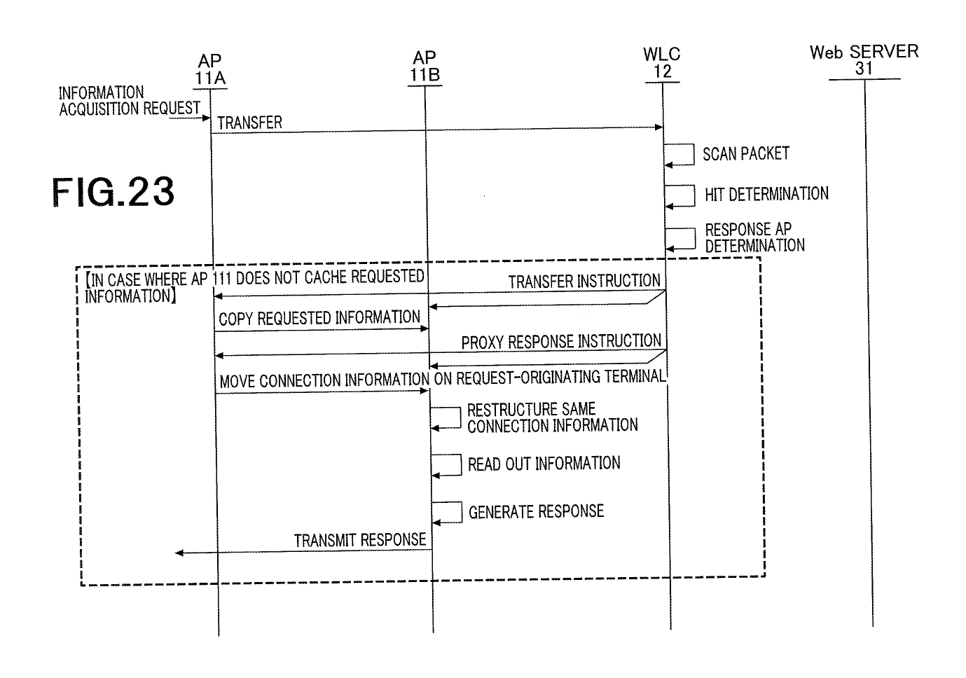

FIG. 23 is a diagram showing another example of the communication sequence of the wireless communication system according to the fifth embodiment. The process until the WLC 12 makes the AP determination is the same as in FIG. 22. If the AP 11B communicable under a good condition does not cache the requested information, the WLC 12 gives the instruction to transfer from the current AP 11A to the AP 11B. The AP 11A receiving this request transfers to the AP 11B the information of target, which the AP 11B saves in its storage. After saving, the proxy response instruction is given, and when finally the connection between the wireless communication terminal 13 and the AP 11B is confirmed and the information is confirmed to be cached in the AP 11B, the AP 11B reads out the instructed information from the storage 1107 to generate the response, and then, transmits the response to the wireless communication terminal 13.

As described above, according to the fifth embodiment, in the situation where the wireless communication terminal 13 is communicable with the plural APs 11, the more suitable AP 11 is selected as compared with the above embodiments, achieving an efficient system taking into account user-friendliness, distribution of the load put on the network and system, and the like.

### Sixth Embodiment

In a sixth embodiment, by use of the plural devices in a wireless system acting in concert with each other, supported is a roaming in a case where the wireless communication terminal 13 moves from the wireless area provided by the AP 11 to the wireless area provided by another AP 11. Note that the sixth embodiment is applicable to the wireless system in the above embodiments, and a description of a configuration of each device and a process in a component included in each device and the like is omitted.

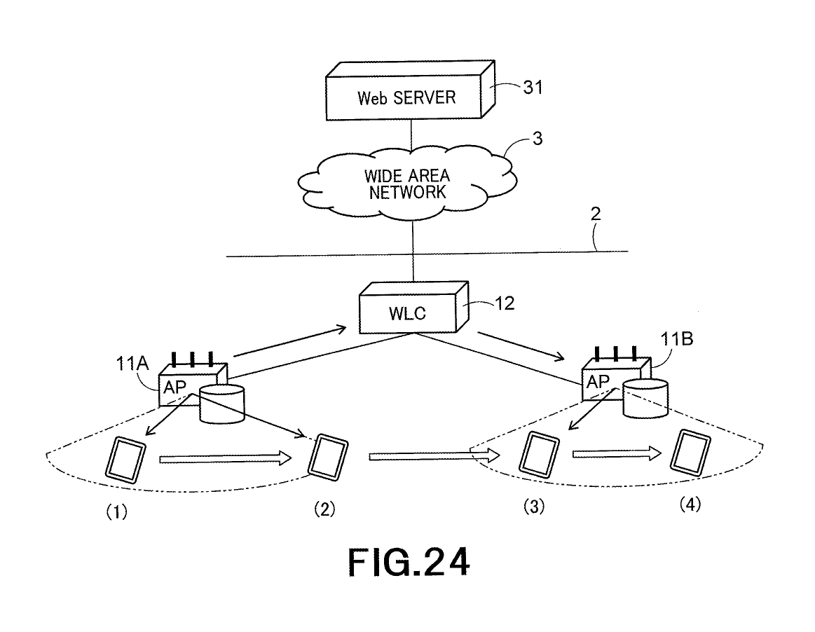

FIG. 24 is a diagram illustrating the wireless communication system according to the sixth embodiment. The APs 11A and 11B managed by the WLC 12 provide the wireless network 1. The wireless communication terminal 13 moves in the wireless network 1 in the order of (1), (2), (3), and (4). The AP 11 transmits the cached information to the wireless communication terminal 13 on the basis of the control by WLC 12 or the like.

When the wireless communication terminal 13 transmits the request at a position (1), the information is transmitted from

AP 11A while the wireless communication terminal 13 moves in the wireless area structured for the AP 11A. However, the communication state is deteriorated when the wireless communication terminal 13 is in an area where wireless signals from the AP 11A is difficult to reach. When the wireless communication terminal 13 goes out of the wireless area structured for the AP 11A, the communication is impossible. When the wireless communication terminal 13 enters a communication range of an AP 11B, it requests the same information in order to acquire the rest of the information. At this time, if the same information is stored in the cache in the AP 11B, transmission is promptly started. However, if not cached, the transfer from the AP 11A or a new acquisition from the web server 31 is needed, generating a new delay.

For this reason, the controller 1105 in the AP 11A, when detecting that the wireless communication terminal 13 as the destination to transmit the cached information becomes close to an outside of the communication range, notifies information concerning the transmitted cached information to the WLC 12 managing the cache. The determination whether or not the wireless communication terminal 13 becomes close to the outside of the communication range may be made based on, for example, a communication quality with the wireless communication terminal 13, such as radiowave intensity decrease, error rate increase, communication impossible time increase, for example.

The controller 1105 in the AP 11A may periodically notify the information concerning the transmitted cached information to the WLC 12 such that the controller 125 in the WLC 12 may detect that the wireless communication terminal 13 as the destination to transmit the cached information becomes close the outside of the communication range on the basis of the information concerning the communication quality.

The AP 11 may also notify information concerning a moving direction of the wireless communication terminal 13 to the WLC 12. For example, there may be included an amount of change in a direction and intensity of the radiowave of the wireless communication terminal 13 received by the AP 11. This information is known to allow the moving direction of the wireless communication terminal 13 to be analogized. The controller 125 in the WLC 12 receives the information concerning the moving direction, and then, identifies the AP 11(a connection-destination AP 11) which is probably to be connected with the relevant wireless communication terminal 13. The information on the AP 11 present in the moving direction may be acquired from the information managed by the wireless network manager 126. This makes it possible for the WLC 12 to instruct the AP 11B to anticipatively fill the cache in a case where the wireless communication terminal 13 is estimated to communicably connect with the AP 11B, for example. Note that it may also be considered that even if the moving direction is not known, but if the terminal 13 is detected to become close to the outside of the communication range of the AP 11A, the WLC 12 may instruct all APs 11 adjacent to the AP 11A to anticipatively cache the information.

The controller 125 in the WLC 12, in the case of transmitting to the AP 11 the instruction to anticipatively cache the information, may specify a range of the information to be cached. If the range is not specified, the instructed AP 11 acquires the cached information of all the range. This gives a general versatility that any range of the cached information can be provided to other wireless communication terminals 13, but causes problems of usage amount increase of the storage, load increase put on the network and AP 11, and the like. In addition, there is a temporal problem whether or not the acquisition of the required range is completed to be acquired before the new request is acquired from the wireless communication terminal 13. If the range is specified, the AP 11 acquires the rest of the cached information other than the already transmitted portion. No general versatility is given that any range of the cached information can be provided to other wireless communication terminals 13, but a problem such as a transfer overhead may be minimized.

Note that the AP 11 is connected with the plural wireless communication terminals 13, each of which requests the different range. In this case, if the ranges of the cached information requested by each of the wireless communication terminals 13 are transferred, the overhead increases. For this reason, the controller 125 in the WLC 12 does not include the portion already cached by the AP 11 into the range to transfer on the basis of the cache management information. The relevant range may be calculated from the cache management information by the cache controller 129.

The information notified by the controller 1105 in the AP 11 to the WLC 12 includes an identifier of the wireless communication terminal 13 as the transmission destination, an identifier of the transmitted cached information, a size of the transmitted information, a location or presumed location range of the wireless communication terminal 13 and the like. The cache controller 129 in the WLC 12 receiving the notification from the AP 11 manages the information on the wireless communication terminal 13 together with the cache management information. Alternatively, the wireless network manager 126 may manage those.

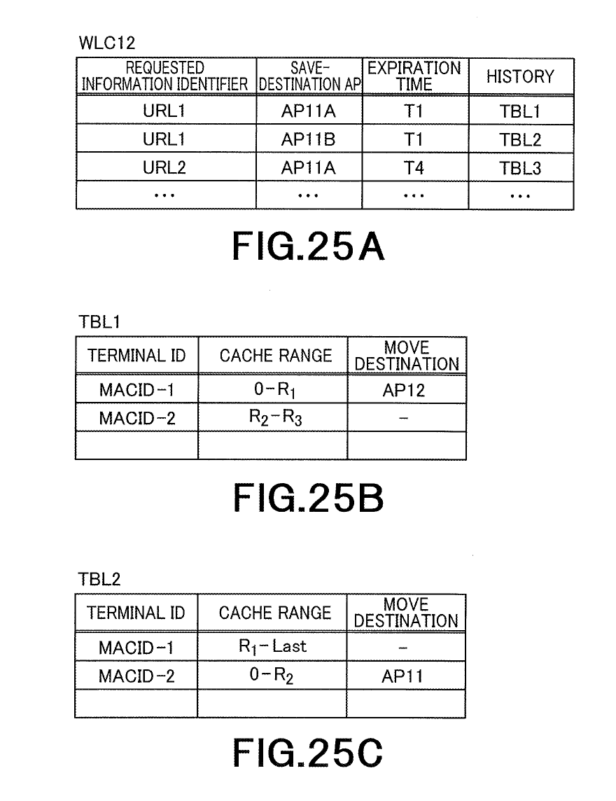

FIGS. 25A to 25C are each a diagram showing an example of the cache management information according to the sixth embodiment. FIG. 25A is a table of the management information regarding the cached information held by the AP 11. Items are merely examples, and other items may be provided. Note that an item “history” shows a name of a table in which detailed information is stored.

In the management information shown in FIG. 25A, the AP 11A and the AP 11B cache for a URL 1, and the cache of the AP 11A and the cache of the AP 11B are managed in a TBL 1 and a TBL 2, respectively. The expiration time for the cache of the URL 1 is T1 for both the AP 11A and the AP 11B. The AP 1 caches for a URL 2, which is managed in a form of a TBL 3.

FIG. 25B shows information on the TBL 1. The TBL 1 stores therein information concerning the wireless communication terminal 13 which is to use or uses the cache of the URL 1 saved in AP 11A. By means of an item of a terminal ID, two wireless communication terminals MACID-1 and MACID-2 are to use or use the cache of the URL 1. An item of a cache range shows a range of the cached information transmitted by the AP 11 to the wireless communication terminal 13. There is shown that the MACID-1 transmits the cached information ranged from 0 to R1, and the MACID-2 transmits the cached information ranged from R2 to R3. An item of a move destination shows a move destination of the wireless communication terminal 13 estimated by the WLC 12. There is shown that the wireless communication terminal 13 of MACID-1 is estimated to be moving in a direction of a wireless area provided by the AP 11B.

FIG. 25C shows information on the TBL 2. The TBL 2 stores therein information concerning the wireless communication terminal 13 which is to use or uses the cache for the URL 1 saved in AP 11B. As described above, the terminal of MACID-1 currently uses the cached information of the URL 1 from the AP 11A, but the move destination thereof is estimated to be the AP 11B. The WLC 12 updates the cache range in the TBL 2 such that when the terminal of MACID-1 uses the AP 11B, the AP 11B transmits a range R1-Last which follows the information transmitted by the AP 11A. If the wireless communication terminal 13 moves to the area provided by the AP 11B, the WLC 12 transmits the updated cache range as the response instruction to the AP 11B, when acquiring the information acquisition request from the AP 11B. This allows the AP 11B to recognize the cache range which is to be transmitted to the wireless communication terminal 13.

Here, if the cached information is managed for each requested information identifier, numerous entries are generated to probably increase the overhead for management. Therefore, the cache range may be made in units of site, or those whose cache ranges are managed may be limited to a specific type of information such as a movie file having a large data size so as to suppress the entries.

In the embodiments described above, the AP 11 has the storage for saving the cached information, but the WLC 12 and the device such as the external server 21 may also have the storage to manage the cache. In a case where the cache is hierarchized, the cache of the information likely to be requested by the moving wireless communication terminal 13 may be controlled to be held not by the AP 11 but the WLC 12 on the upper layer than the AP 11 or the external server 21. Here, the wireless communication terminal 13 on the content receiving side is on the lower layer, and the logically closer to the web server 31 or the like on the content transmitting side, the upper layer.

The information cached for each hierarchy may be managed by the device performing the hit determination. For example, if the WLC 12 performs the hit determination, the WLC 12 may manage the information cached between the storage of the WLC 12 and the APs 11. For example, the external server 21, the WLC 12 and the AP 11 constitute a three layered configuration, the uppermost external server 21 may centrally manage the cache, or the external server 21 may manage the cache of the lower WLC 12 and the WLC 12 may manage the cache of the lower AP 11.

An efficient management method depends on an operational policy of the system. For example, if a policy is taken that the duplication of the information to save is reduced as much as possible, the information referred by the plural devices is collected in the upper storage. If a policy is taken that the delay is reduced, it may be considered that the information with a higher reference frequency is saved in a lower storage as close as possible to the wireless communication terminal 13. The reference frequency may be determined on the basis of a predetermined threshold. The information having a larger size than a predetermined size may be saved in the lower storage or the storage having a larger storage size. The management method may be considered that the storages are differently used depending on the type of the information. Note that the management method is not limited to these examples and plural management methods may be combined.

In addition, in a case where the information is shared with another storage, the information stored in an original storage needs to be managed. For example, if the information is transferred to another storage, it may be deleted from the original storage or may be left. The processing details may be changed depending on the conditions such as the transfer destination of the information and a storage state. For example, the information is deleted if the transfer destination is an upper storage, and left if a lower storage. It may be considered that the information is left if an initial capacity of the storage of the transfer destination is small, deleted if the initial capacity is large, or deleted if a free space of the storage of the transfer destination is less than a threshold. These conditions may be fixedly set in the cache controller 1109 or saved in the storage 1110 so as to be adequately referred. The process like this is not limited to only a case where a hierarchical structure is given, but may be applicable to a case of performing the transfer process in the above embodiments.

As described above, according to the sixth embodiment, even if the wireless communication terminal 13 moves from the wireless area provided by the connection destination AP 11, the cached information of the required range is saved in the move destination AP 11 in advance. This allows the wireless communication terminal 13 to utilize the cached information immediately even after moving, and can suppress a network usage amount, the processing loads put on the devices, and a time taken for the process.

### Seventh Embodiment

In the above embodiments, the devices performing the processes are predetermined such as that the AP 11 performs the packet scanning and the WLC 12 performs the hit determination. However, only the specific device is not necessarily fixed to perform the process. In other words, the device performing the process may be changed depending on the load status of the device, the number of the connected wireless communication terminals and the like. In a case where there are plural devices of the same type, a device may perform a predetermined process and another same device may not perform a predetermined process. For example, the AP 11A may perform the packet scanning and the hit determination, whereas the AP 11B may perform the packet scanning but not perform the hit determination and the AP 11C may perform the hit determination but not perform the packet scanning. Accordingly, a seventh embodiment controls a process of a device present in the wireless system.

In the seventh embodiment, both the AP 11 and the WLC 12 probably perform all processes of the packet scanning, the hit determination, and the content acquisition, and thus, the AP 11 is configured to include an acquirer 1111 in addition to the third embodiment. The WLC 12 has the same configuration as the first embodiment.

This control may be performed by the controller 125 in the WLC 12. Alternatively, the component managing the information or cached information on the wireless system such as the wireless network manager 126, cache controller 129 or the like may use the information to manage as the information for controlling the system to control the devices performing the processes. For example, if the control is performed on the basis of the number of the wireless communication terminals connected with the AP 11, the wireless network manager 126 grasping the number of the wireless communication terminals may perform. Alternatively, the devices may cooperate each other such that the controller 1105 or the like in the AP 11 may determine whether or not the control is performed based on the number of the wireless communication terminals, and the WLC 12 may determine whether or not the determination by the AP 11 is accepted based on the load status of the WLC 12 or the like.

Control information and control details may be as below.

[1] The number of wireless communication terminals connected with the APs 11

Depending on the number of the wireless communication terminals connected with each AP 11, it is determined, for each AP 11, whether or not all or a part of processes of the packet scanning, the hit determination, and the content acquisition are performed. The process not performed by AP 11 is performed by the WLC 12.

### [2] Load Put on Device

Depending on the load put on each AP 11 and WLC 12, such as a CPU load, I/O wait processes number, I/O queue length, a response time with respect to a predetermined message, and a processing time, it is determined, for each AP 11, whether or not all or a part of processes of the packet scanning, the hit determination, and the content acquisition are performed. The process not performed by AP 11 is performed by the WLC 12.

[3.] Traffic (communication traffic)

Depending on the traffic processed by each AP 11 and the WLC 12, it is determined, for each AP 11, whether or not the process regarding the cache such as the hit determination is performed. If not performed, the WLC 12 performs that process. Note that this traffic may be the all traffics processed by the devices, or may be those between specific devices or regarding only a specific communication. For example, there may be used a total of communication traffics regarding the requests from the wireless communication terminals 13 and the responses thereto, or the communication traffics in transferring the information between the APs 11.

[4.] The number of processes performed by devices

Depending on the number of the processes such as the number of the requests transmitted, for example, per a second to each AP 11 and the WLC 12, it is determined, for each AP 11, whether or not all or a part of processes of the packet scanning, the hit determination, and the content acquisition are performed. The process not performed by AP 11 is performed by the WLC 12.

The information collected by the WLC 12 for managing the AP 11 may utilize as the control information, or the control information may be newly collected. A frequency of collecting the control information may be determined freely. The collection may be performed periodically at a predetermined collection interval, or may be collected irregularly. A process of deciding the device performing the process on the basis of the collected control information may be performed for each parameter collection, or at a certain time period interval determined in advance, or at every time zone while the wireless communication terminal 13 is used.

As for the process determined not to be performed by the AP 11, the controller 125 or the like in WLC 12 instructs the controller 1105, transfer detector controller 1108, cache controller 1109, or acquirer 1111 in the AP 11 to stop the relevant process. As for the process determined not to be performed by the WLC 12, the wireless network manager 126 in WLC 12 instructs the transfer detector 123, controller 125, cache controller 129, and acquirer 127 in the WLC 12 to stop the relevant process. However, the WLC 12 may stop the process for a part of the APs 11 in some cases, and thus, instructs about the process not to perform. The components in the WLC 12 and AP 11 given the instruction to stop the process from the wireless network manager 126 do not perform the relevant specified process until receiving an instruction to start the stopped process. This makes it possible to change the device performing the process, depending on the load status of the device, the number of the wireless communication terminals connected and the like.

The components stopping the process may be put into a power-off state or a lower power consumption state by lowering in an operational clock frequency such that consumption energy can be reduced. Therefore, if the controller 1105 in the AP 11 is made to perform power-supply control, further electric power saving may be attained.

Note that in a case where the components are achieved by virtualization, information on whether or not the process is performed on the basis of the control information may be output to a user or the like, for control of a state of an instance of virtualization, for example, states of execution, stop, suspend and the like, or for utilizing a migration function.

As described above, according to the seventh embodiment, a change of a system usage condition is flexibly addressed, achieving distribution of the load put on the entire system and electric power saving.

The processes in the devices (e.g., AP 11, WLC 12) in the embodiments described above can be implemented by software (program). Thus, the devices in the embodiments described above such as the AP 11 and the WLC 12 can be implemented by, for example, using a general purpose computer device as basic hardware to cause a processor mounted on the computer device to execute the program.

The components in the devices may be achieved by dedicated hardware. Alternatively, a plurality of components may be one piece of hardware, for example, an SoC (System On a Chip). It may be achieved by an independent virtual server or an isolated application execution environment.

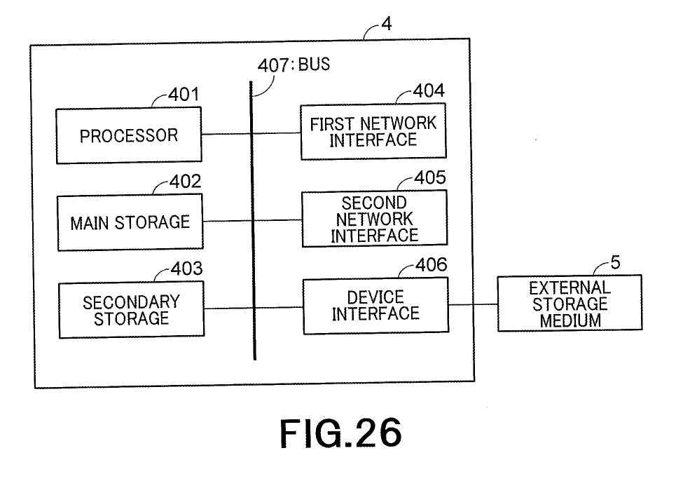

FIG. 26 is a block diagram showing an exemplary hardware configuration in which the wireless communication device (AP 11 and WLC 12) according to the embodiment is achieved. The AP 11 and the WLC 12 include a processor 401, a main storage 402, an auxiliary storage 403, a first network interface 404, a second network interface 405, and a device interface 406, and may be achieved as a computer device in which these components are connected with each other via a bus 407.

Parts for reducing the load put on the processor 401 such as an accelerator and an offroad engine may be added to the hardware configuration. For example, the network interface may include a TCP/IP offroad engine such that the transferer 1103, TCP/IP processor 1104 or transfer detector 1108 in the AP 11, or the transfer detector 123 or TCP/IP processor 124 in the WLC 12 may be achieved not by the processor 401 but by the first and second network interfaces 404 and 405. Alternatively, a complex process such as a TCP option or an exceptional process such as an error handling may be performed by the processor 401, and the basic process for the TCP/IP, for example, the process regarding bit pattern matching may be performed by the TCP/IP offroad engine. Alternatively, if the load status of the processor 401 exceeds a threshold, a part of the processes performed by the processor 401 may be performed by the accelerator, the offroad engine or the like.

Further, a power-supply control device may be added to the hardware configuration, and a function of the power-supply control may be installed in the processor 401, the first network interface 404, or the second network interface 405.

The processor 401 reads out the program from the auxiliary storage 403, loads it into the main storage 402 and executes, which achieves the functions of the transferer 1103, TCP/IP processor 1104, controller 1105, transfer detector 1108, cache controller 1109, and acquirer 1111 in the AP 11, and the functions of the transfer detector 123, TCP/IP processor 124, controller 125, wireless network manager 126, acquirer 128, and cache controller 129 in the WLC 12.

The first network interface 404 and the second network interface 405 are each an interface for connecting with the communication network. The first and second network interfaces correspond to the wired interface 1101 and wireless interface 1102 in the AP 11, and the wired interface 121 and wired interface 122 in the WLC 12.

The device interface 406 is an interface connecting with a device such as an external storage medium 5. For example, the device interface 406 corresponds to a SATA controller, a SCSI controller, an eMMC controller, a NAND controller and the like, and a storage system constituted by a combination thereof are applicable. The device interface 406 corresponds to the storage controller 1106.

The external storage medium 5 may be any storage medium such as an HDD, a CD-R, a CD-RW, a DVD-RAM, a DVD-R, and a SAN (Storage area network). The storage 1107 and storage 1110 in AP 11, and the storage 127 in the WLC 12, and the mass storage in which the WLC 12 transitorily stores the acquired information may be connected with the device interface 406 as the external storage medium 5.

The AP 11 and WLC 12 in the embodiment may be achieved by installing in advance the programs executed by the AP 11 and WLC 12 into the computer device, or by storing the program in the storage medium such as the CD-ROM or distributing via the network to install into the computer device.

The main storage 402 is a memory device transitorily storing an instruction executed by the processor 401 and various pieces of data, and may be a volatile memory such as a DRAM or a non-volatile memory such as an MRAM and a NAND flash. The auxiliary storage 403 is a storage permanently storing the program, the data and the like. The auxiliary storage 403 may be an HDD or an SSD, for example. The storage 1110 in the AP 11 and the storage 127 in the WLC 12 may be achieved by the main storage 402 or the auxiliary storage 403.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
a communication interface configured to form a wireless connection with a wireless communication terminal;
a transferer configured to transfer a communication request acquired from the wireless communication terminal via the wireless connection by way of the communication interface or a different communication interface to a communication device which extracts a requested information identifier;
a storage configured to store given information;
a storage controller configured to write, read out, or delete information in the storage; and
a first controller configured to, in a case of receiving a save instruction from the communication device, instruct the storage controller to save information sent thereto in the storage, and, in a case of receiving a response instruction from the communication device, instruct the storage controller to read out information specified by the response instruction from the storage to transmit the information read out by the storage controller via the wireless connection to the wireless communication terminal specified by the response instruction.

2. The wireless communication device according to claim 1, wherein
the first controller, in a case of receiving a transfer instruction from the communication device, instructs the storage controller to read out information specified by the transfer instruction from the storage to transmit the information read out by the storage controller by way of the communication interface or a different communication interface to another wireless communication device specified by the transfer instruction.

3. The wireless communication device according to claim 1, wherein
the first controller, in a case of receiving a proxy response instruction from the communication device, instructs the storage controller to read out information specified by the proxy response instruction from the storage to transmit, in place of the other wireless communication device to which the wireless communication terminal sent the communication request, the information read out by the storage controller via the wireless connection to the wireless communication terminal specified by the proxy response instruction.

4. The wireless communication device according to claim 1, further comprising:
a first acquirer configured to acquire information on the basis of the requested information identifier,
wherein the first controller, in a case of receiving the save instruction from the communication device, instructs the first acquirer to acquire the information on the basis of the requested information identifier from a second communication device specified by the save instruction, and instructs the storage controller to save the information acquired by the first acquirer in the storage.

5. The wireless communication device according to claim 1, further comprising:
in place of the transferer, a first transfer detector configured to extract the requested information identifier from the communication request and transmit the requested information identifier to the communication device,
wherein the first transfer detector extracts the requested information identifier in place of the communication device.

6. The wireless communication device according to claim 5, further comprising:
a first cache controller configured to determine whether or not information on the basis of the requested information identifier extracted by the first transfer detector is stored in the storage,
wherein the first controller, in a case where it is determined by the first cache controller that the information on the basis of the requested information identifier is stored, transmits the information on the basis of the requested information identifier to the wireless communication terminal which sent the communication request, and in a case where it is determined by the first cache controller that the information on the basis of the requested information identifier is not stored, transmits to the communication device an instruction to acquire the information on the basis of the requested information identifier together with the requested information identifier.

7. The wireless communication device according to claim 4, wherein
the first acquirer, from the information on the basis of the requested information identifier or history information on information acquisition of the wireless communication terminal, estimates information newly requested by the wireless communication terminal to acquire the estimated information before the wireless communication terminal newly requests to acquire information.

8. A communication device, comprising:
a second transfer detector configured to extract a requested information identifier from a communication request derived from the wireless communication terminal, the communication request being sent from a wireless communication device which forms a wireless connection with the wireless communication terminal;
a second cache controller configured to, on the basis of cache management information indicating whether or not information on the basis of the requested information identifier is stored in a storage included in the wireless communication device, determine whether or not the wireless communication device holds the information on the basis of the requested information identifier; and
a second controller configured to, in a case where the second cache controller determines that the wireless communication device holds the information on the basis of the requested information identifier, give the wireless communication device a response instruction to send the information on the basis of the requested information identifier held by the wireless communication device to the wireless communication terminal.

9. The communication device according to claim 8, further comprising:
a second acquirer configured to acquire the information on the basis of the requested information identifier,
wherein the second controller,
in a case where the second cache controller determines from the cache management information that no wireless communication device holds the information on the basis of the requested information identifier, instructs the second acquirer to acquire the information on the basis of the requested information identifier from a second communication device specified by the communication request,
gives the wireless communication device a save instruction to save the information acquired by the second acquirer in the storage and the response instruction, and
in a case where the second cache controller determines from the cache management information that the wireless communication device which transferred the communication request does not hold the information on the basis of the requested information identifier, but another wireless communication device holds the information on the basis of the requested information identifier, gives the other wireless communication device a proxy response instruction to send the information on the basis of the requested information identifier held by the other wireless communication device to the wireless communication terminal, or a transfer instruction to transfer that information to the wireless communication device which sent the communication request.

10. The communication device according to claim 9, wherein
the second transfer detector does not extract the requested information identifier, and instead, the requested information identifier is acquired from the wireless communication device.

11. The communication device according to claim 10, wherein
the second controller, in a case of acquiring a determination result that no wireless communication device holds the information on the basis of the requested information identifier from the wireless communication device, instructs the second acquirer to acquire the information on the basis of the requested information identifier.

12. The communication device according to claim 9, wherein
the second controller selects one of the plural wireless communication devices based on a predetermined selection method, and gives the selected wireless communication device at least one of the response instruction, the save instruction, the proxy response instruction, and the transfer instruction.

13. The communication device according to claim 12, wherein
in the selection method, an order of priority is decided on the basis of information concerning a condition of each of the plural wireless communication devices, and one wireless communication device is selected in accordance with the order of priority.

14. The communication device according to claim 9, wherein
the second controller calculates a connection-destination wireless communication device which is the wireless communication device connected with wireless communication terminal at a move destination of the wireless communication terminal on the basis of information concerning a moving direction of the wireless communication terminal, and
in a case where the second cache controller determines that the information being currently transmitted to the wireless communication terminal is not stored in the storage of the connection-destination wireless communication device, the second controller gives a transfer instruction to transfer to the connection-destination wireless communication device to any wireless communication device which is determined by the second cache controller to hold the information being currently transmitted to the wireless communication terminal, or gives a save instruction to the connection-destination wireless communication device.

15. The communication device according to claim 14, wherein
the second controller decides a range of the information to be transmitted to the connection-destination wireless communication device on the basis of a range of the information already transmitted of the information being currently transmitted to the wireless communication terminal.

16. The communication device according to claim 9, wherein
the second controller, from the information on the basis of the requested information identifier or history information on information acquisition of the wireless communication terminal, estimates information newly requested by the wireless communication terminal, and
the second acquirer acquires the estimated information before the wireless communication terminal newly requests to acquire the information.

17. The communication device according to claim 9, wherein
the second controller sends the information on the basis of the requested information identifier or the history information on the information acquisition of the wireless communication terminal to a third communication device, and acquires a new requested information identifier from the third communication device to acquire the information on the basis of the new requested information identifier from the second communication device, or acquires the information on the basis of the new requested information identifier from the third communication device.

18. The communication device according to claim 16, wherein
the controller decides an amount of the estimated information on the basis of the condition of the wireless communication device.

19. The communication device according to claim 9, wherein
the second controller, on the basis of information concerning conditions of the communication device and each wireless communication device, gives each wireless communication device a stop instruction or start instruction of a process performed by the wireless communication device, and instructs the second transfer detector, the second cache controller, and the second acquirer to stop or start the process in accordance with the stop instruction or start instruction of the process.

20. A wireless communication system comprising:
a wireless communication device configured to form a wireless connection with a wireless communication terminal; and
a communication device configured to communicate with the wireless communication device,
wherein the wireless communication device includes
a communication interface configured to form a wireless connection with the wireless communication terminal,
a transferer configured to transfer a communication request acquired from the wireless communication terminal via the wireless connection by way of the communication interface or a different communication interface to the communication device which extracts a requested information identifier,
a storage configured to store given information,
a storage controller configured to, write, read out, and delete information in the storage, and
a first controller configured to, in a case of receiving a save instruction from the communication device, instruct the storage controller to save information sent thereto in the storage, and, in a case of receiving a response instruction from the communication device, instruct the storage controller to read out information specified by the response instruction from the storage to transmit the information read out by the storage controller via the wireless connection to the wireless communication terminal specified by the response instruction, and
the communication device includes
a second transfer detector configured to extract a requested information identifier from a communication request derived from the wireless communication terminal which is sent from a wireless communication device,
a second cache controller configured to, on the basis of cache management information indicating whether or not information on the basis of the requested information identifier is stored in a storage included in the wireless communication device, determine whether or not the wireless communication device holds the information on the basis of the requested information identifier, and
a second controller configured to, in a case where the second cache controller determines that the wireless communication device holds the information on the basis of the requested information identifier, give the wireless communication device the response instruction to send the information on the basis of the requested information identifier held by the wireless communication device to the wireless communication terminal.

21. A wireless communication system comprising:
a wireless communication device configured to form a wireless connection with a wireless communication terminal; and
a communication device configured to communicate with the wireless communication device,
wherein the wireless communication device includes
a communication interface configured to form a wireless connection with the wireless communication terminal,
a transfer detector configured to extract a requested information identifier from a communication request acquired from the wireless communication terminal via the wireless connection and transmit the requested information identifier to the communication device,
a storage configured to store given information,
a storage controller configured to write, read out, and delete information in the storage, and
a first controller configured to, in a case of receiving a save instruction from the communication device, instruct the storage controller to save information sent thereto in the storage, and, in a case of receiving a response instruction from the communication device, instruct the storage controller to read out information specified by the response instruction from the storage to transmit the information read out by the storage controller via the wireless connection to the wireless communication terminal specified by the response instruction, and
the communication device includes
a second cache controller configured to, on the basis of cache management information indicating whether or not information on the basis of the requested information identifier is stored in a storage included in the wireless communication device, determine whether or not the wireless communication device holds the information on the basis of the requested information identifier, and
a second controller configured to, in a case where the second cache controller determines that the wireless communication device holds the information on the basis of the requested information identifier, give the wireless communication device the response instruction to send the information on the basis of the requested information identifier held by the wireless communication device to the wireless communication terminal.

22. A wireless communication system comprising:
a wireless communication device configured to form a wireless connection with a wireless communication terminal; and
a communication device configured to communicate with the wireless communication device,
wherein the wireless communication device includes
a communication interface configured to form a wireless connection with the wireless communication terminal,
a transfer detector configured to extract a requested information identifier from a communication request acquired from the wireless communication terminal via the wireless connection and transmit the requested information identifier to the communication device,
a cache controller configured to determine whether or not information on the basis of the requested information identifier extracted by the transfer detector is stored in the storage,
a storage configured to store given information,
a storage controller configured to write, read out, and delete information in the storage, and
a first controller configured to, in a case of receiving a save instruction from the communication device, instruct the storage controller to save information sent thereto in the storage, and, in a case where it is determined that the information on the basis of the requested information identifier is stored, transmit the information on the basis of the requested information identifier to the wireless communication terminal which sent the communication request, and, in a case where it is determined by that the information on the basis of the requested information identifier is not stored, transmit to the communication device an instruction to acquire the information on the basis of the requested information identifier together with the requested information identifier, and
the communication device includes
a second acquirer configured to acquire the information on the basis of the requested information identifier, and
a second controller configured to, in a case of being instructed to acquire the information on the basis of the requested information identifier by the wireless communication device, instruct the second acquirer to acquire the information on the basis of the requested information identifier.
